(19) United States
(12) Patent Application Publication
(10) Pub. No.: US 2026/0067482 A1
(43) Pub. Date: Mar. 5, 2026

(54) SYSTEMS AND METHODS OF SEPARATING RESIDUAL INFORMATION INTO MULTIPLE CHANNELS FOR DECODING OR ENCODING

(71) Applicant: QUALCOMM Incorporated, San Diego, CA (US)

(72) Inventors: Jeon Hak MOON, Incheon (KR); Sanghyun JUNG, Suwon-si (KR); Seongman LEE, Gimpo (KR); Youngkwang OK, Seoul (KR)

(21) Appl. No.: 18/816,573

(22) Filed: Aug. 27, 2024

(51) Int. Cl. H04N 19/436; H04N 19/186

(52) U.S. Cl. CPC H04N 19/436; H04N 19/186

(57) ABSTRACT

A device includes a memory configured to store a bitstream corresponding to video data. The device also includes one or more processors coupled to the memory. The one or more processors are configured to obtain residual information from the bitstream. The one or more processors are also configured to distribute residual data based on the residual information into multiple residual channels to enable parallel decoding using the residual data from each residual channel of the multiple residual channels.

### I. FIELD

The present disclosure is generally related to image decoding and encoding.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to receive a video signal from a video camera or from another device as part of a bitstream. The video signal may represent a sequence of image frames that is recorded by the camera or that is for display at a display device. To enable display of the video signal, a stream processor parses and decodes a received bitstream into header information and residual information which are then processed by a pixel processor to generate output image frames. To enable transmission of image frames generated by a camera, the pixel processor processes the image frames to generate header information and residual information that is encoded and combined by the stream processor to generate a bitstream that can be sent to another device. Because some visual information in images (e.g., luma) is more human-sensitive than other visual information (e.g., chroma), the more human-sensitive visual information is often sampled at a higher rate than the less human-sensitive visual information to reduce video bandwidth. As such, the information generated by the stream processor can be twice the size of an encoded bitstream that represents a sequence of image frames. However, as technology progresses, new encoding formats that include increased numbers of samples of visual or pixel information, particularly chroma samples, have been developed. Encoding or decoding these new formats without an increased delay may require nearly double the decoding and encoding performance of the stream processer and the pixel processor, which can significantly increase cost and complexity of these processors, in addition to increasing power consumption of the device.

### III. SUMMARY

According to one implementation of the present disclosure, a device includes a memory configured to store a bitstream corresponding to video data. The device also includes one or more processors coupled to the memory. The one or more processors are configured to obtain residual information from the bitstream. The one or more processors are also configured to distribute residual data based on the residual information into multiple residual channels to enable parallel decoding using the residual data from each residual channel of the multiple residual channels.

According to another implementation of the present disclosure, a method includes obtaining, by one or more processors, residual information from a bitstream that corresponds to video data. The method also includes distributing, by the one or more processors, residual data based on the residual information into multiple residual channels to enable parallel decoding using the residual data from each residual channel of the multiple residual channels.

According to another implementation of the present disclosure, a device includes a memory configured to store video data. The device also includes one or more processors coupled to the memory. The one or more processors are configured to process an image frame of the video data to generate, in parallel, multiple sets of residual data distributed into multiple residual channels. The one or more processors are also configured to encode the multiple sets of residual data from the multiple residual channels to generate residual information. The one or more processors are further configured to output a bitstream that represents the video data based on the residual information.

According to another implementation of the present disclosure, a method includes processing, by one or more processors, an image frame of video data to generate, in parallel, multiple sets of residual data distributed into multiple residual channels. The method also includes encoding, by the one or more processors, the multiple sets of residual data from the multiple residual channels to generate residual information. The method also includes outputting, by the one or more processors, a bitstream based on the residual information, the bitstream representing the video data.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of particular aspects of a system that includes a device operable to separate residual information into multiple channels for decoding, in accordance with some examples of the present disclosure.

FIG. 2 is a block diagram of particular aspects of a system that includes a device operable to separate residual information into multiple channels for encoding, in accordance with some examples of the present disclosure.

FIG. 3 is a diagram of an illustrative example of operation of a stream processor and a pixel processor and includes separation of residual information into multiple channels for decoding, in accordance with some examples of the present disclosure.

FIG. 4 is a diagram of an illustrative example of operation of a stream processor and a pixel processor and includes separation of residual information into multiple channels for encoding, in accordance with some examples of the present disclosure.

FIG. 5 illustrates an example of a system that includes an integrated circuit operable to separate residual information into multiple channels for decoding or encoding, in accordance with some examples of the present disclosure.

FIG. 6 is a diagram of an illustrative aspect of a system that includes a mobile device operable to separate residual information into multiple channels for decoding or encoding, in accordance with some examples of the present disclosure.

FIG. 7 is a diagram of an illustrative aspect of a system that includes a wearable electronic device operable to separate residual information into multiple channels for decoding or encoding, in accordance with some examples of the present disclosure.

FIG. 8 is a diagram of an illustrative aspect of a system that includes a mixed reality or augmented reality glasses operable to separate residual information into multiple channels for decoding or encoding, in accordance with some examples of the present disclosure.

FIG. 9 is a diagram of an illustrative aspect of a system that includes a wireless speaker and voice-activated device operable to separate residual information into multiple channels for decoding or encoding, in accordance with some examples of the present disclosure.

FIG. 10 is a diagram of an illustrative aspect of a system that includes a camera device operable to separate residual information into multiple channels for decoding or encoding, in accordance with some examples of the present disclosure.

FIG. 11 is a diagram of an illustrative aspect of a system that includes a headset device, such as a virtual reality, mixed reality, or augmented reality headset, operable to separate residual information into multiple channels for decoding or encoding, in accordance with some examples of the present disclosure.

FIG. 12 is a diagram of a first example of a system that includes a vehicle operable to separate residual information into multiple channels for decoding or encoding, in accordance with some examples of the present disclosure.

FIG. 13 is a diagram of a second example of a system that includes a vehicle operable to separate residual information into multiple channels for decoding or encoding, in accordance with some examples of the present disclosure.

FIG. 14 is a diagram of a particular implementation of a method of separating residual information into multiple channels for decoding, in accordance with some examples of the present disclosure.

FIG. 15 is a diagram of a particular implementation of a method of separating residual information into multiple channels for encoding, in accordance with some examples of the present disclosure.

FIG. 16 is a block diagram of a particular illustrative implementation of a device that is operable to separate residual information into multiple channels for decoding or encoding, in accordance with some examples of the present disclosure.

### V. DETAILED DESCRIPTION

Computing devices often incorporate a coder/decoder (codec) to play media files for a user or to create and send media files to other devices. As an example, a codec may receive and decode a bitstream to generate a sequence of image frames to be displayed at a display device. As another example, a codec may receive a sequence of image frames from a video camera for display at the display device or for encoding into a bitstream to be transmitted to another device via a network (e.g., a wired network, a wireless network, or a combination thereof). A device that implements a codec may include a stream processor and a pixel processor to perform at least some of the encoding and decoding operations that support the codec. To enable a received bitstream (e.g., from another device) to be decoded to a sequence of image frames, the stream processor parses and processes the bitstream into header information (e.g., coding unit size, coding unit predictions, coding unit shapes, motion vectors, etc., associated with the image frames.) and residual information (e.g., samples of residual coefficients associated with the image frames), and the pixel processor processes the information streams from the stream processor to output a representation of the sequence of image frames (e.g., such as for display at a display device). To enable a received sequence of image frames (e.g., from a video camera or other source) to be encoded into a representative bitstream, the pixel processor processes the image frames to generate header information and residual information, and the stream processor processes and combines the information streams from the pixel processor to generate the bitstream (e.g., for transmission to another device).

During a typical decoding process, the pixel processor processes the header information and the residual information in parallel to improve decoding performance. To enable this parallel processing, the stream processor parses the bitstream into header information and residual information in a manner that resolves syntax parsing dependency between the two information streams, and each of the two information streams (e.g., the header information and the residual information) can be distributed to a respective channel for that stream in a buffer between the stream processor and the pixel processor. In some popular digital video encoding schemes, a video signal is split into different visual components: luminance (luma) and chrominance (chroma), which can include multiple chroma components such as blue-difference chroma (Cb) and red-difference chroma (Cr). The luma components may be more perceptible to humans (e.g., more human sensitive) than the chroma components, and thus in video encoding schemes, the luma component may be sampled at a first sampling rate and the chroma components may be sampled (e.g., “subsampled) at a second sampling rate that is lower than the first sampling rate. As an illustrative, non-limiting example, the 4:2:0 color format is associated with sampling the chroma components at ¼th the sampling rate of the luma component, such that for a 16×16 unit of an image frame, 256 luma samples, 64 Cb samples, and 64 Cr samples are sampled, resulting in a total of 384 samples per unit.

As demand for improved quality video increases, newer encoding schemes are being developed to provide higher resolution video. Some examples include the 4:2:2 color format and the 4:4:4 color format, which include more chroma samples per unit than the 4:2:0 color format. For the 16×16 unit described above and in addition to the same 256 luma samples, the 4:2:2 color format includes 128 Cb samples and 128 Cr samples, resulting in a total of 512 samples per unit (e.g., an approximately 1.33 times increase from the 4:2:0 color format), and the 4:4:4 color format includes 256 Cb samples and 256 Cr samples, resulting in a total of 768 samples per unit (e.g., an approximately 2 times increase from the 4:2:0 color format). For a pixel processor that performs approximately 144 decoding cycles per MB, the decoding performance associated with decoding the 4:2:0 color format is approximately 2.67 samples per cycle. However, because the 4:2:2 and 4:4:4 color formats include more samples than the 4:2:0 color format, to maintain the same decoding speed and not introduce delay, which may be perceptible to a user viewing the video, the number of samples processed per cycle would increase to approximately 3.56 samples per cycle for the 4:2:2 color format or to approximately 5.33 samples per cycle for the 4:4:4 color format. Thus, supporting newer encoding formats with larger numbers of samples may require significantly increased processing speeds for pixel processors or delays associated with the playback of higher resolution video. Similar processing speed increases may be required to encode bitstreams based on the newer formats without incurring delay in transmitting the bitstreams. Such processing performance may be associated with significantly increased cost and pixel processor complexity, as well as increased power consumption, which may prevent some devices such as mobile communication devices from supporting the newer encoding formats.

Systems and methods of separating residual information (e.g., streams of residual coefficient values) into multiple channels for decoding are disclosed. For example, a device includes one or more processors that are configured to obtain residual information from a bitstream and to distribute residual data based on the residual information into multiple residual channels. Distributing the residual data into the multiple residual channels enables parallel decoding using the residual data from each residual channel of the multiple residual channels. For example, the one or more processors may include a stream processor that parses the bitstream into header information and the residual information and that distributes the residual data into a first residual channel for luminance residual information at a buffer and one or more other residual channels for chrominance residual information at the buffer. In some implementations, the stream processor distributes some of the residual data into a second residual channel for first chrominance residual information (e.g., Cb residual information) and a third residual channel for second chrominance residual information (e.g., Cr residual information). Additionally, or alternatively, the stream processor may distribute header data based on the header information into a header channel at the buffer. The one or more processors may also include a pixel processor that is configured to read, in parallel, a respective set of residual data from each of the multiple residual channels at the buffer and to process, in parallel, the retrieved residual data from each of the residual channels (in some implementations in addition to the header data from the header channel) to generate a representation of a sequence of image frames encoded in the bitstream. By distributing the residual data into multiple distinct residual channels in the buffer and processing the various types of residual data in parallel, video data encoded with higher resolution encoding schemes such as the 4:2:2 or 4:4:4 color formats can be decoded at the same speed (e.g., without increasing decoding performance of the pixel processor) and using the same buffer size as associated with conventional video decoding codecs that support other encoding formats such as the 4:2:0 color formats.

Similarly, a device includes one or more processors that are configured to process one or more image frames to generate, in parallel, multiple sets of residual data that are distributed into multiple residual channels. The multiple sets of residual data are combined with header data from the pixel processor and encoded to output a bitstream that represents the image frame(s). For example, the one or more processors may include a pixel processor that is configured to process the image frame(s) to generate and distribute respective sets of residual data to a first residual channel for luminance residual information at a buffer and one or more other residual channels for chrominance residual data at the buffer. In some implementations, the pixel processor distributes some of the residual data into a second residual channel for first chrominance residual information (e.g., Cb residual information) at the buffer and a third residual channel for second chrominance residual information (e.g., Cr residual information) at the buffer, as well as generating and distributing header data to a header channel at the buffer. The one or more processors may also include a stream processor that is configured to read, in parallel, the multiple sets of residual data from the multiple residual channels at the buffer and to encode and combine the retrieved residual data from each of the residual channels (in some implementations in addition to the header data from the header channel) to generate a bitstream that represents the image frame(s). By processing the image frame(s) to generate the various types of residual data in parallel and distributing the residual data into multiple distinct residual channels in the buffer, video data with higher resolution encoding schemes such as the 4:2:2 or 4:4:4 color formats can be encoded as a bitstream at the same speed (e.g., without increasing encoding performance of the pixel processor) and using the same buffer size as associated with conventional video encoding codecs that support other encoding formats such as 4:2:0 color format.

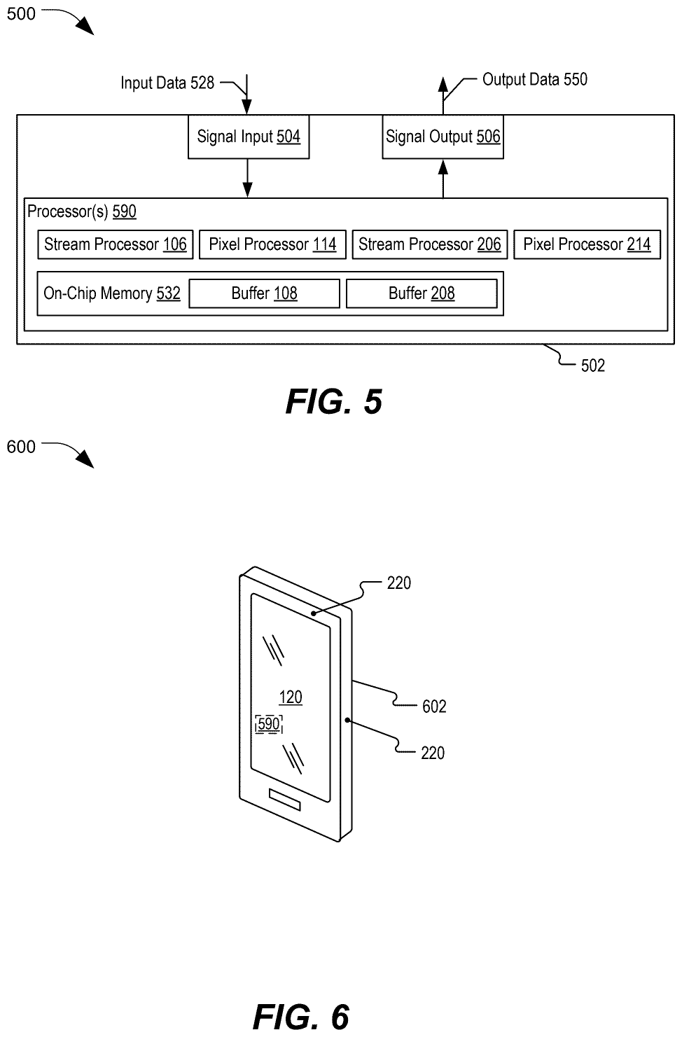

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 5 depicts an integrated circuit 502 including one or more processors (“processor(s)” 590 of FIG. 5), which indicates that in some implementations the integrated circuit 502 includes a single processor 590 and in other implementations the integrated circuit 502 includes multiple processors 590. For ease of reference herein, such features are generally introduced as “one or more” features and are subsequently referred to in the singular or optional plural (as indicated by “(s)”) unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality”refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

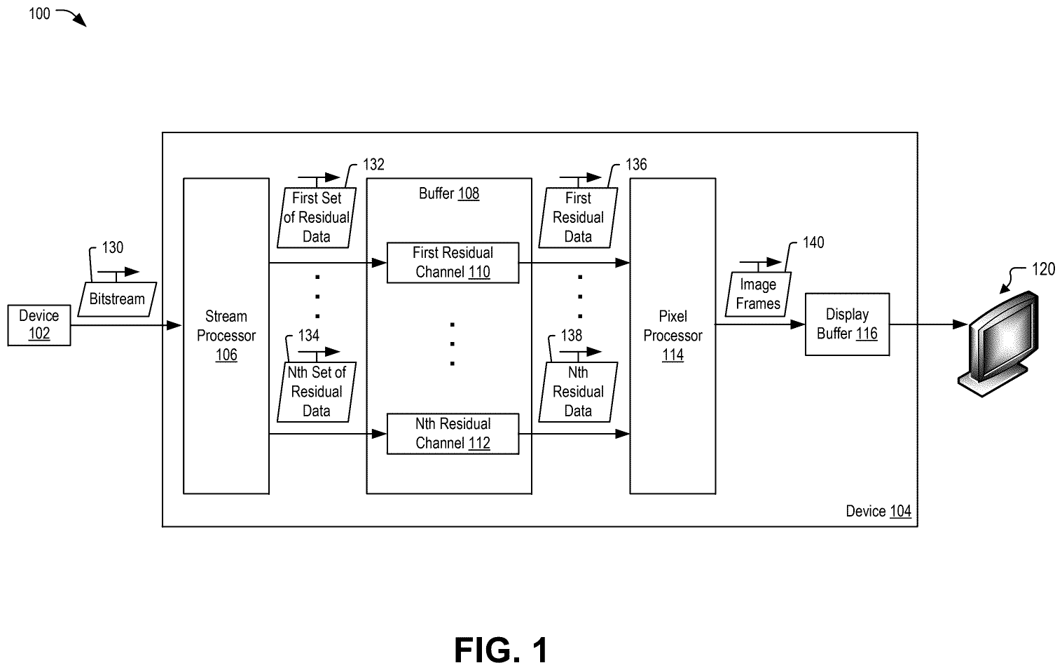

FIG. 1 is a block diagram of particular aspects of a system 100 that includes a device 104 operable to separate residual information into multiple channels for decoding. The system 100 includes the device 104 that is configured to be coupled via a network (e.g., a wired network, a wireless network, or both) to a device 102. The device 102 is configured to share bitstream data that represents a sequence of image frames, such as video data, with one or more other devices (including the device 104) via the network. For example, the device 102 may be a dedicated transmitting device and the device 104 may be a dedicated receiving device of bitstream data.

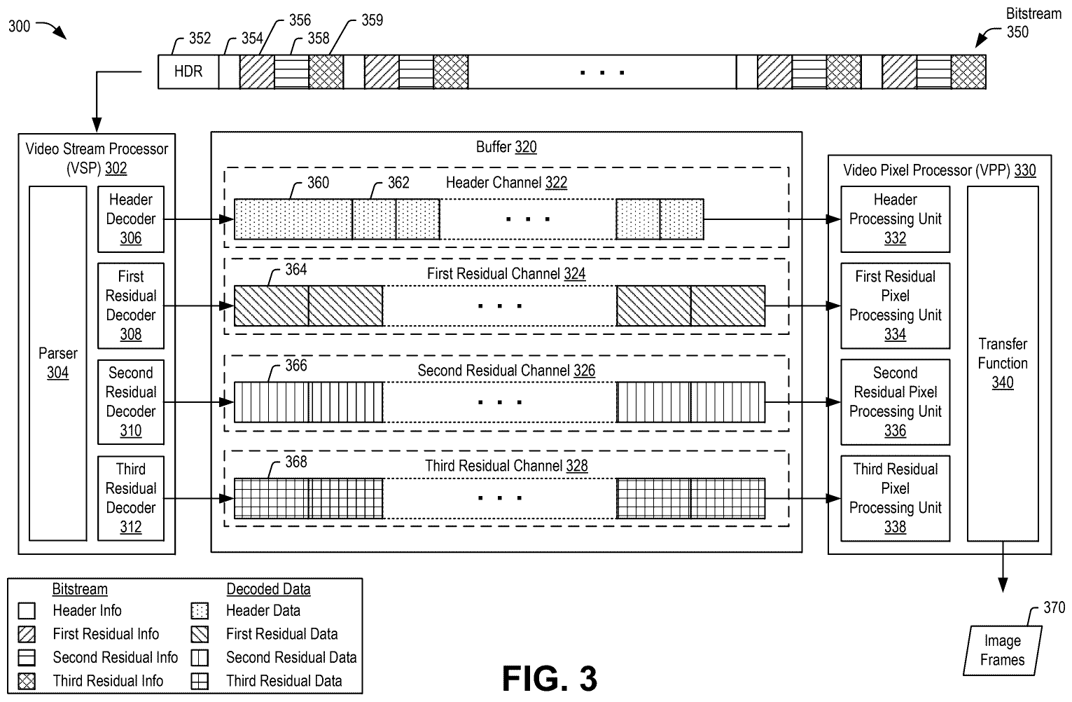

The device 104 includes a stream processor 106 (e.g., a video stream processor) coupled to a buffer 108. In some implementations, the stream processor 106 includes a parser and one or more decoders. The stream processor 106 is configured to obtain a bitstream 130 from the device 102, to parse and process the bitstream to identify residual information, and to distribute residual data based on the residual information into multiple residual channels of the buffer 108. For example, the residual data may include multiple sets of residual data that are distributed into the multiple residual channels at the buffer 108, such as a first set of residual data 132 and an Nth set of residual data 134. In some implementations, the first set of residual data 132 includes or corresponds to luminance (luma) residual data and the remaining sets of residual data (e.g., the Nth set of residual data 134) include or correspond to chrominance (chroma) residual data, such as blue-difference chrominance (Cb) residual data and red-difference chrominance (Cr) residual data. Although two sets of residual data are shown in FIG. 1, in other implementations, the stream processor 106 distributes the residual data into more than two sets of residual information in more than two respective channels (e.g., N may be greater than two). In some implementations, the stream processor 106 is also configured to identify header information in the bitstream 130 and to distribute header data based on the header information into a header channel of the buffer 108, as further described herein with reference to FIG. 3.

The buffer 108 includes multiple residual channels configured to buffer various sets of residual data. For example, the buffer 108 may include a first residual channel 110 and an Nth residual channel 112. Although two residual channels are shown in FIG. 1, in other implementations, the buffer 108 includes more than two residual channels (e.g., N may be greater than two). In some implementations, the buffer 108 also includes a header channel configured to buffer header information, as further described herein with reference to FIG. 3. In some implementations, the device 104 includes a buffer manager (not shown) to manage the buffer 108, to manage reads from and writes to the buffer 108, or a combination thereof.

The device 104 also includes a pixel processor 114 (e.g., a video pixel processor) coupled to the buffer 108. In some implementations, the pixel processor 114 includes at least one of a prediction engine, a transform engine, or a filter engine. Additionally, or alternatively, the pixel processor 114 includes one or more processing units, a transfer function, or a combination thereof. The pixel processor 114 is configured to read, in parallel, a respective set of residual data from each of the multiple residual channels at the buffer 108 and to process the respective sets of residual data, in parallel, to generate a representation of image frames 140. For example, the pixel processor 114 may read, in parallel, first residual data 136 from the first residual channel 110 and Nth residual data 138 from the Nth residual channel 112, and process the first residual data 136 in parallel with the Nth residual data 138 (e.g., the first residual data 136 is processed concurrently with, or during overlapping time periods with, the processing of the Nth residual data 138), to generate one or more of the image frames 140.

Optionally, in some implementations, the pixel processor 114 is coupled, via a display buffer 116, to a display 120 (e.g., a display device). The display 120 is shown as external to the device 104 as an illustrative example, in other examples the display 120 is integrated in the device 104. The pixel processor 114 stores the image frames 140 in the display buffer 116 to be played out on the display 120.

In some implementations, the device 104 includes a system-on-chip that includes on-chip memory, the stream processor 106, and the pixel processor 114, and the on-chip memory includes the buffer 108. Additionally, or alternatively, the device 104 may include a modem (not shown) coupled to the stream processor 106 and to the device 102 (e.g., via a network or a direct wireless connection). In such implementations, the modem is configured to receive the bitstream 130 from the device 102.

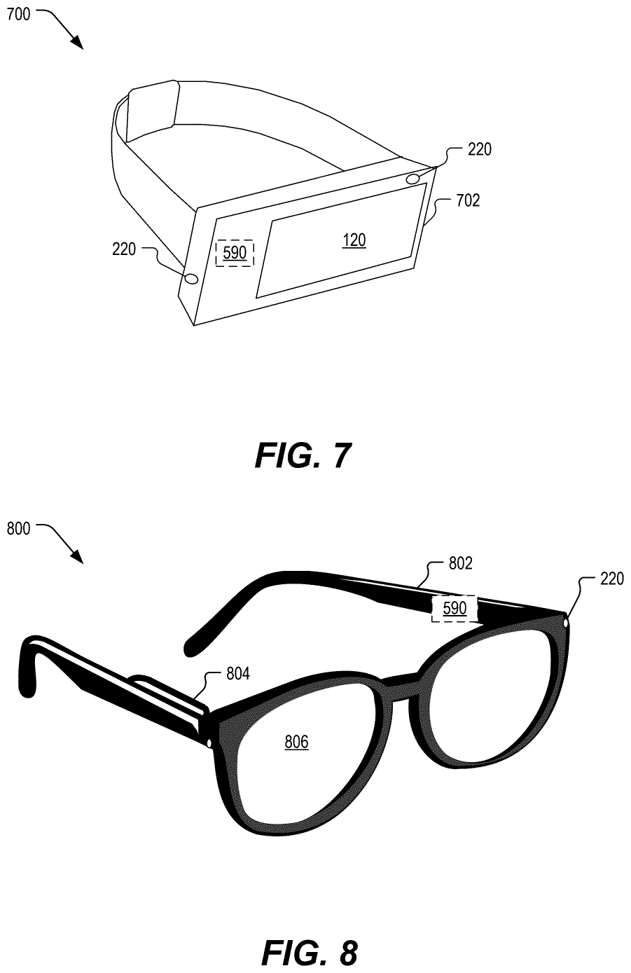

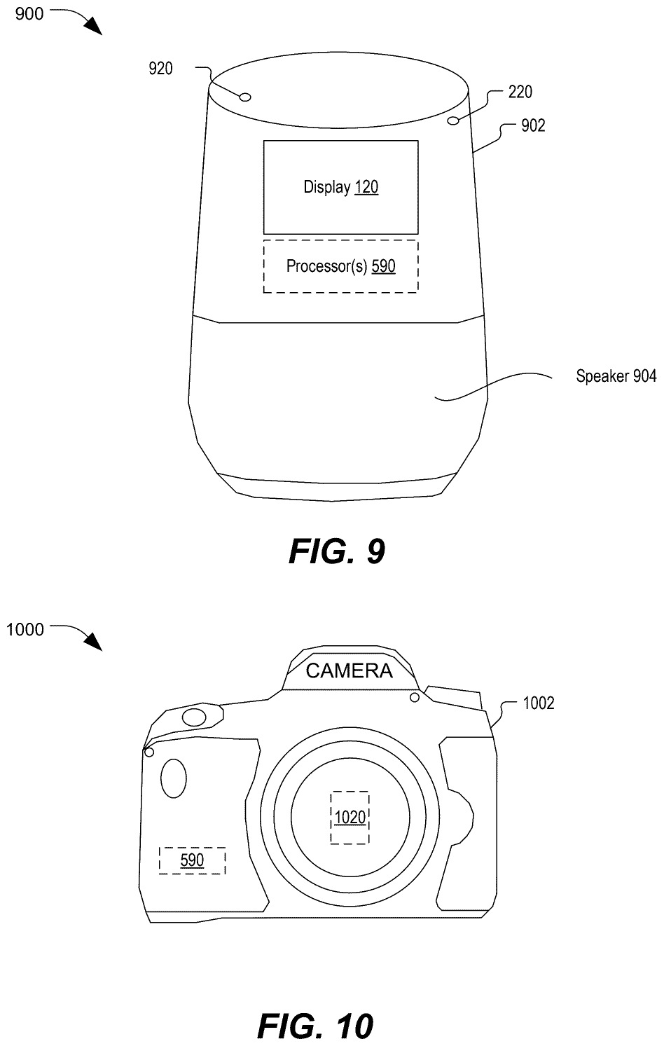

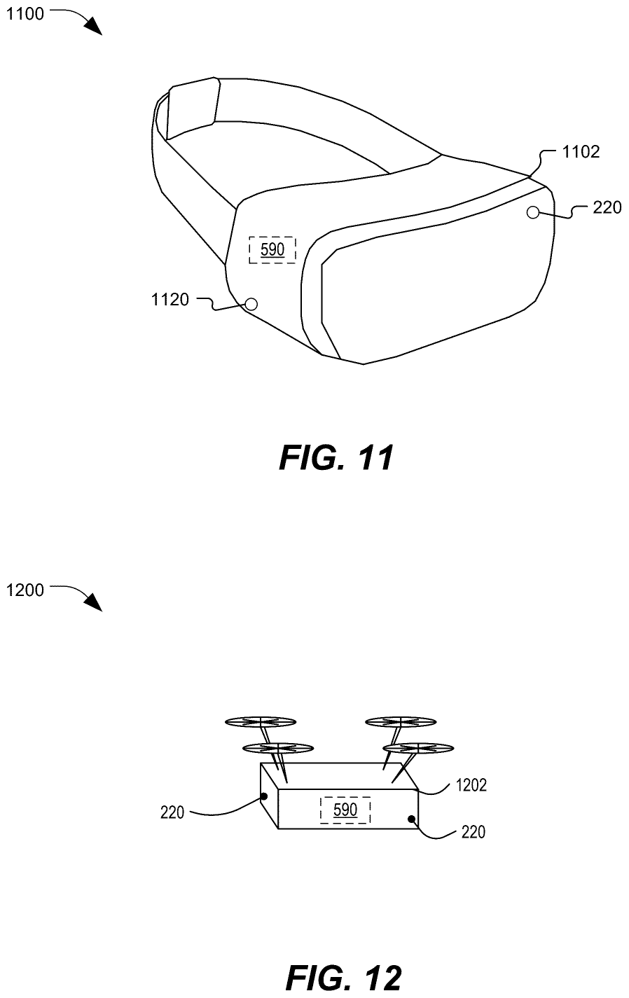

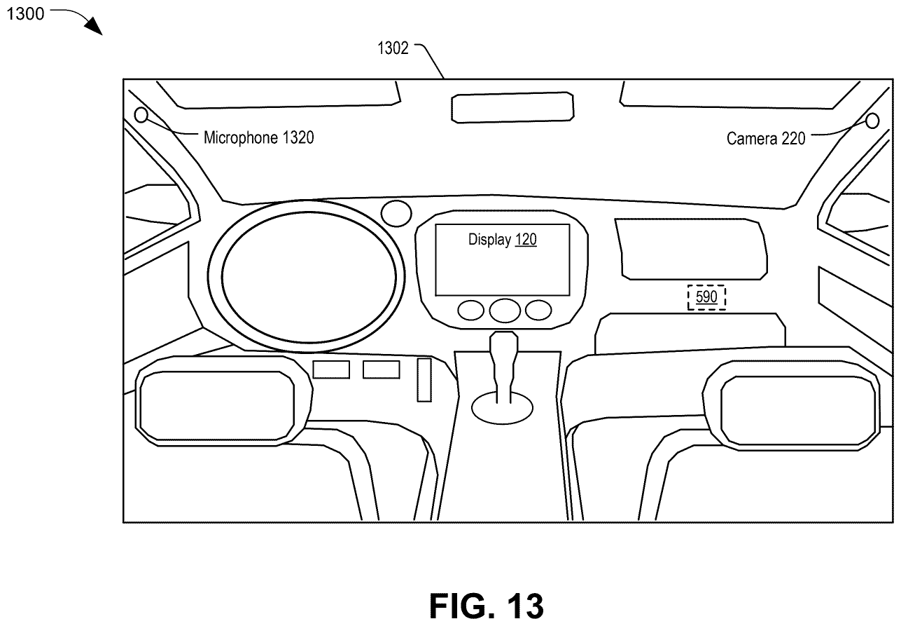

In some implementations, the device 104 corresponds to or is included in one of various types of devices. In an illustrative example, the device 104 corresponds to or is included in at least one of a mobile device, as described with reference to FIG. 6, a wearable electronic device, as described with reference to FIG. 7, augmented reality or mixed reality glasses, as described with reference to FIG. 8, a wireless speaker and voice-activated device, as described with reference to FIG. 9, a camera device, as described with reference to FIG. 10, or a headset device, such as a virtual reality, mixed reality, or augmented reality headset, as described with reference to FIG. 11. In another illustrative example, the device 104 corresponds to or is included in a vehicle, such as described further with reference to FIG. 12 and FIG. 13.

During operation, the device 104 receives the bitstream 130 from the device 102. In some implementations, the bitstream 130 is stored in a jitter buffer (not shown) for retrieval by the stream processor 106. The stream processor 106 receives (or retrieves from the jitter buffer) the bitstream 130 and, as the bitstream 130 is received, the stream processor 106 parses the bitstream 130 into header information and multiple types of residual information. The header information may represent characteristics or parameters associated with each portion of the image frames represented as units by the bitstream 130 and may include or represent a coding unit (CU) size, a prediction associated with the CU, a shape associated with the CU, a motion vector associated with the CU, a transform unit (TU) size, other information related to residual information that corresponds to the header information, or a combination thereof. The CU may include or correspond to a portion of an image frame having a particular size. The residual information may represent or include samples of one or more residual coefficients associated with the CU (e.g., a portion of an image of the sequence of images represented by the bitstream 130). In some examples, the residual information includes or represents luma coefficient samples (e.g., values), Cb coefficient samples, Cr coefficient samples, or a combination thereof.

The stream processor 106 also processes, including performing at least some decoding operations on, the multiple types of residual information to generate multiple sets of residual data that are then distributed by the stream processor 106 to the buffer 108. The decoding operations may include reconstruction, prediction, transforming, filtering, other operations, or a combination thereof, to generate data (e.g., data indicating syntax information, macroblock header and coefficients, etc.) representing the image frame. In some implementations, the decoding operations include entropy decoding operations or the stream processor 106 includes or is configured as an entropy decoder. The generated data from the stream processor 106 includes header information that may be distributed to a header channel, as further described herein with reference to FIG. 3, and multiple sets of residual data corresponding to multiple types of residual information. The residual data may include residual coefficients associated with a respective type of residual information (e.g., luma residuals, chroma residuals, etc.), other values, or a combination thereof, such as coefficients and values associated with luma information and chroma information, as a non-limiting example.

After generating the residual data, the stream processor 106 distributes the residual data to respective channels of the buffer 108. The process of parsing and decoding the bitstream 130 is repeated for additional image frames encoded in the bitstream 130, and the different types of residual data are similarly distributed to the multiple channels of the buffer 108 as respective sets of residual data. For example, the stream processor 106 distributes the first set of residual data 132 to the first residual channel 110 of the buffer 108, and the stream processor 106 distributes the Nth set of residual data 134 to the Nth residual channel 112 of the buffer 108. In some implementations, the image frames encoded in the bitstream 130 are encoded with luma and chroma information, and in such implementations, the first set of residual data 132 corresponds to luma residual data and the remaining sets of residual data (e.g., the Nth set of residual data 134) correspond to chroma residual data. As an example, the first set of residual data 132 may include luma residual data, a second set of residual data (e.g., residual data distributed to a second residual channel of the buffer 108) corresponds to first chroma residual data, and the Nth set of residual data 134 corresponds to second chroma residual data. In other implementations, the image frames of the bitstream 130 are encoded with other types of visual or pixel information (e.g., according to other video encoding schemes), and the sets of residual data and the channels of the buffer 108 correspond to different types of data.

The pixel processor 114 obtains residual data from the buffer 108 and performs pixel processing operations on the residual data (and header data, in some implementations) to generate the image frames 140. In some implementations, the pixel processor 114 retrieves residual data from the residual channels 110-112 of the buffer 108 for one image frame at a time in order to process, in parallel, the various types of residual data to generate one of the image frames 140. For example, the pixel processor 114 may perform pixel processing operations on the first residual data 136 retrieved from the first residual channel 110 and the Nth residual data 138 retrieved from the Nth residual channel 112, in parallel, to generate a first image frame of the image frames 140. The pixel processor 114 may continue to read and process, in parallel, residual data from the channels of the buffer 108 to generate other image frames of the image frames 140. Optionally, in some implementations, the device 104 provides the image frames 140 to the display buffer 116 to playout at the display 120.

The device 104 thus enables the stream processor 106 to parse and distribute residual information encoded in the bitstream 130 into multiple residual channels of the buffer 108 for reading and processing, in parallel, by the pixel processor 114. One technical advantage of implementing the device 104 as described above is increasing the amount of residual information that can be decoded and processed to generate image frames without increasing the decoding speed (e.g., decoding performance), or incurring a delay in the playback of the image frames, as compared to other devices that decode bitstream data to generate image frames. For example, because the residual information is split into the sets of residual data 132-134 that are stored at the residual channels 110-112 of the buffer 108, the pixel processor 114 is able to decode each type of residual data in parallel, which increases a number of samples of residual data that can be processed by the pixel processor 114 without incurring a delay. As such, the pixel processor 114 may be able to decode image data that is encoded according to higher resolution video encoding schemes, such as the 4:2:2 color format and the 4:4:4 color format without incurring additional delay as compared to image data that is encoded according to the 4:2:0 color format or other formats, and without significantly increasing the processing resource usage and power consumption of the pixel processor 114.

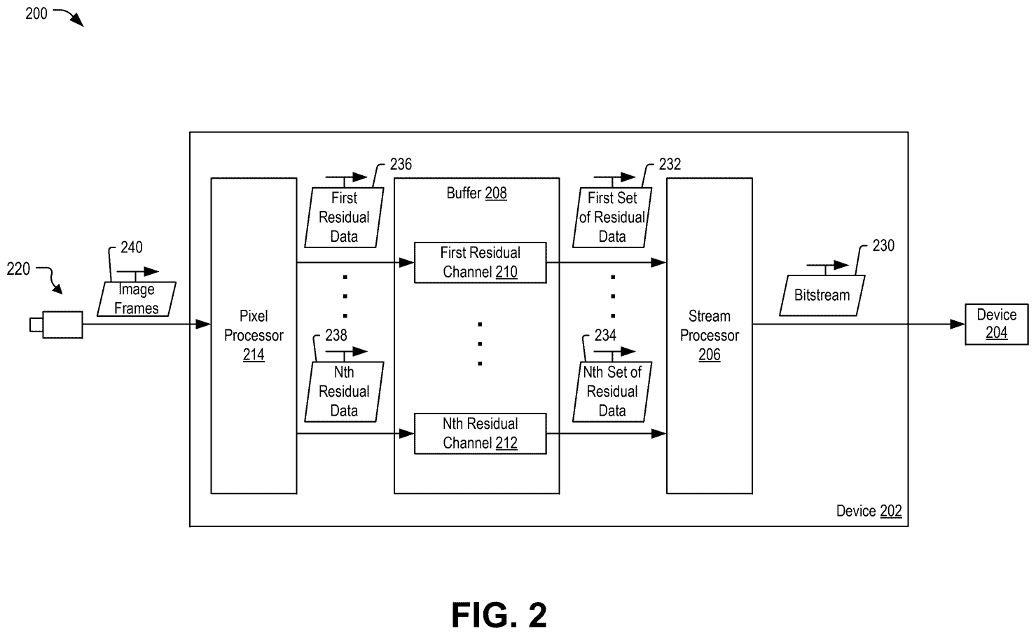

FIG. 2 is a block diagram of particular aspects of a system 200 that includes a device 202 operable to separate residual information into multiple channels for encoding. The system 200 includes the device 202 that is coupled to a camera 220 (e.g., an image sensor, a video camera, or both), and a device 204. The camera 220 is illustrated as external to the device 202 as an illustrative example, in other examples the camera 220 can be integrated in the device 202. In some aspects, the device 202 is configured to be coupled via a network (e.g., a wired network, a wireless network, or both) to the device 204.

The device 202 is configured to share bitstream data that represents a sequence of image frames, such as video data, with one or more other devices (including the device 204) via the network. In some implementations, the device 202 and the device 204 correspond to the device 102 and the device 104 of FIG. 1, respectively. For example, the device 202 (e.g., the device 102) is a dedicated transmitting device and the device 204 (e.g., the device 104) is a dedicated receiving device of a bitstream 230 (e.g., the bitstream 130). In some other implementations, the device 202 of FIG. 2 can be a receiving device for one bitstream and a transmitting device for another bitstream. For example, the device 202 can be a transmitting device of the bitstream 230 to the device 204, as described with reference to FIG. 2; additionally, the device 202 can include one or more components of the device 104 of FIG. 1 and be a receiving device of bitstream 130 from the device 102. To illustrate, the device 202 may transmit the bitstream 230 to the device 204 and receive another bitstream from another device, or the device 202 may transmit the bitstream 230 to the device 204 and receive another bitstream from the device 204.

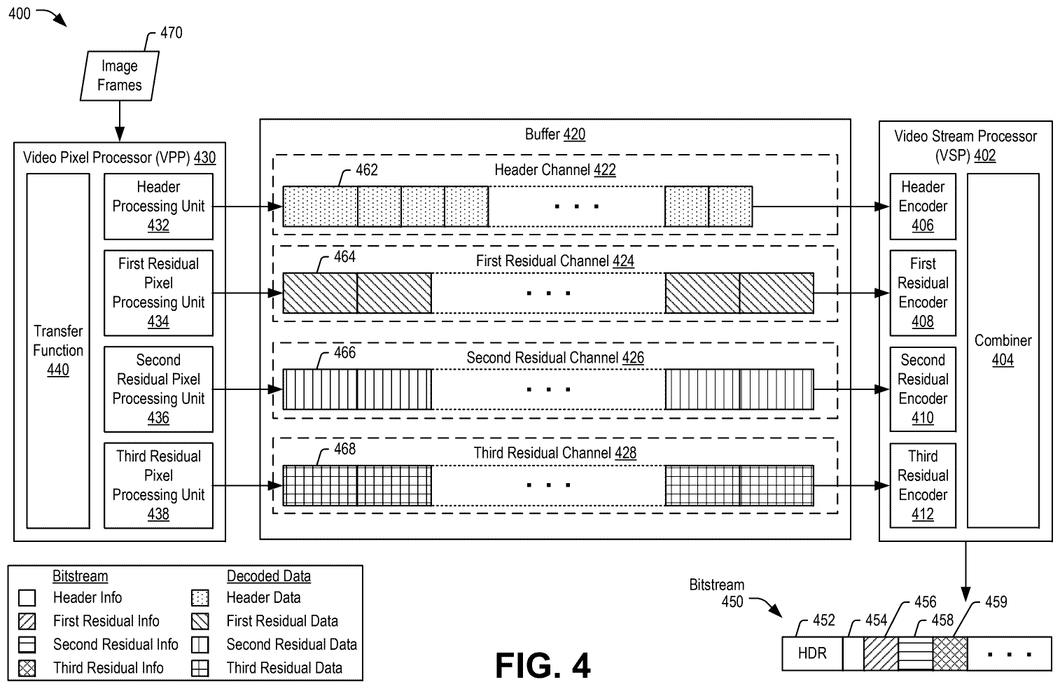

The device 202 includes a pixel processor 214 (e.g., a video pixel processor) coupled to a buffer 208. The pixel processor 214 may obtain the image frames 240 from the camera 220, or from a camera buffer (not shown), and perform pixel processing operations on the image frames 240. In some implementations, the pixel processor 214 includes at least one of a prediction engine, a transform engine, or a filter engine. Additionally, or alternatively, the pixel processor 214 includes one or more processing units, a transfer function, or a combination thereof. The pixel processor 214 is configured to process (e.g., to encode by performing pixel processing operations on) the image frames 240 to generate, in parallel, multiple sets of residual data that are distributed into multiple residual channels at the buffer 208. For example, the pixel processor 214 may process one of the image frames of the image frames 240 to generate, in parallel, first residual data 236 and Nth residual data 238 (e.g., the processing of the image frame to generate the first residual data 236 is processed concurrently with, or during, overlapping time periods with, the processing of the image frame to generate the Nth residual data 238). The first residual data 236 is distributed to a first residual channel 210 at the buffer 208 and the Nth residual data 238 is distributed to an Nth residual channel 212 at the buffer 208. In some implementations, the first residual data 236 includes or corresponds to luma residual data and the remaining residual data (e.g., the Nth residual data 238) include or correspond to chroma residual data, such as Cb residual data and Cr residual data, as non-limiting examples. Although two types of residual data are shown in FIG. 2, in other implementations, the pixel processor 214 distributes the residual data into more than two sets of residual information in more than two respective channels (e.g., N may be greater than two). In some implementations, the pixel processor 214 is also configured to generate header data from the image frames 240 and to distribute header data into a header channel of the buffer 208, as further described herein with reference to FIG. 4.

The buffer 208 includes multiple residual channels configured to buffer various sets of residual data. For example, the buffer 208 may include a first residual channel 210 and an Nth residual channel 212. Although two residual channels are shown in FIG. 2, in other implementations, the buffer 208 includes more than two residual channels (e.g., N may be greater than two). In some implementations, the buffer 208 also includes a header channel configured to buffer header data, as further described herein with reference to FIG. 4. In some implementations, the device 202 includes a buffer manager (not shown) to manage the buffer 208, to manage reads from and writes to the buffer 208, or a combination thereof.

The device 202 also includes a stream processor 206 (e.g., a video stream processor) coupled to the buffer 208. In some implementations, the stream processor 206 includes one or more encoders and a combiner. The stream processor 206 is configured to read multiple sets of residual data from the multiple residual channels at the buffer 208 in parallel and to encode the multiple sets of residual data as a bitstream 230 (e.g., bitstream data). For example, the multiple sets of residual data may include a first set of residual data 232 that is read from the first residual channel 210 and an Nth set of residual data 234 that is read from the Nth residual channel 212. In some implementations, the stream processor 206 is also configured to read header data from a header channel of the buffer 208 in parallel with reading the sets of residual data 232-234 in order to encode and combine the received data as the bitstream 230, as further described herein with reference to FIG. 4. In some implementations, the bitstream 230 includes or corresponds to the bitstream 130 of FIG. 1. The device 202 may be configured to transmit the bitstream 230 that is output by the stream processor 206 to one or more other devices, such as the device 204.

In some implementations, the device 202 includes a system-on-chip that includes on-chip memory, the stream processor 206, and the pixel processor 214, and the on-chip memory includes the buffer 208. Additionally, or alternatively, the device 202 may include a modem (not shown) coupled to the stream processor 206 and to the device 204 (e.g., via a network or a direct wireless connection). In such implementations, the modem is configured to transmit the bitstream 230 to the device 204.

In some implementations, the device 202 corresponds to or is included in one of various types of devices. In an illustrative example, the device 202 corresponds to or is included in at least one of a mobile device, as described with reference to FIG. 6, a wearable electronic device, as described with reference to FIG. 7, augmented reality or mixed reality glasses, as described with reference to FIG. 8, a wireless speaker and voice-activated device, as described with reference to FIG. 9, a camera device, as described with reference to FIG. 10, or a headset device, such as a virtual reality, mixed reality, or augmented reality headset, as described with reference to FIG. 11. In another illustrative example, the device 104 corresponds to or is included in a vehicle, such as described further with reference to FIG. 12 and FIG. 13.

During operation, the device 202 receives the image frames 240 from the camera 220. In some implementations, the camera 220 stores the sequence of the image frames 240 in a camera frame buffer (not shown). In some aspects, the image frames 240 are received from the camera 220 at a fixed rate, such as 30 image frames per second or another rate, which may be based on a configuration setting, default data, a user input, or a combination thereof. The pixel processor 214 receives (or retrieves from the camera frame buffer) the image frames 240 and performs pixel processing operations on the image frames 240 to generate, in parallel, header data and multiple types of residual data that are then distributed by the pixel processor 214 to the buffer 208. The pixel processing operations may be performed in accordance with a video encoding scheme, such as the 4:4:4 color format or the 4:2:2 color format, as non-limiting examples. The generated data from the pixel processor 214 includes header data that may be distributed to a header channel, as further described herein with reference to FIG. 4, and multiple sets of residual data corresponding to the image frames 240. The residual data may include residual coefficients associated with a respective type of residual information, other values, or a combination thereof, such as coefficients and values associated with luma information and chroma information, as a non-limiting example.

After generating the residual data, the pixel processor 214 distributes the residual data to respective channels of the buffer 208. For example, the pixel processor 214 may distribute the first residual data 236 to the first residual channel 210 at the buffer 208 and the Nth residual data 238 to the Nth residual channel 212. The process of processing and encoding an image frame is repeated for the remainder of the image frames 240, and the different types of residual data are similarly distributed to the multiple channels of the buffer 208 as respective residual data. In some implementations, the image frames 240 are to be encoded with luma and chroma information, and in such implementations, the first residual data 236 corresponds to luma residual data and the remaining residual data (e.g., the Nth residual data 238) correspond to chroma residual data. As an example, the first residual data 236 may include luma residual data, second residual data (e.g., residual data distributed to a second residual channel of the buffer 208) may correspond to first chroma residual data, and the Nth residual data 238 may correspond to second chroma residual data. In other implementations, the pixel processor 214 is configured to encode the image frames 240 according to a different type of video encoding scheme, and the types of residual data and the channels of the buffer 208 correspond to different types of data.

The stream processor 206 obtains, in parallel, sets of the residual data from the buffer 208, and the stream processor 206 combines and encodes the residual data (and header data, in some implementations) to generate the bitstream 230. In some implementations, the stream processor 206 retrieves residual data from the residual channels 210-212 of the buffer 208 in parallel for one image frame at a time in order to combine and encode, in parallel, the various types of residual data to generate a portion of the bitstream 230. For example, the stream processor 206 may read, in parallel, the first set of residual data 232 from the first residual channel 210 and the Nth set of residual data 234 retrieved from the Nth residual channel 212 to generate residual information that may optionally be combined with header information and encoded to output the bitstream 230. Optionally, in some implementations, the device 202 transmits the bitstream 230 to the device 204 via the network.

The device 202 thus enables the pixel processor 214 to generate multiple types of residual data, in parallel, for distribution into multiple residual channels of the buffer 208 for reading and encoding, in parallel, by the stream processor 206. One technical advantage of implementing the device 202 as described above is increasing the amount of residual data that can be processed and encoded to generate a bitstream for transmission to another device without increasing the encoding speed (e.g., encoding performance), and thus incurring a delay in the transmission of the bitstream, as compared to other devices that encode image data into bitstreams. For example, because the residual data 236-238 can be generated and stored in the residual channels 210-212 of the buffer 208, the pixel processor 214 is able to encode each type of residual data in parallel, which increases a number of samples of residual data that can be processed by the pixel processor 214 without incurring a delay. As such, the pixel processor 214 may be able to encode image data according to higher resolution video encoding schemes, such as the 4:2:2 color format and the 4:4:4 color format, without incurring additional delay as compared to encoding the image data according to the 4:2:0 color format or other formats, and without significantly increasing the processing resource usage and consumption of the pixel processor 214. FIG. 3 is a diagram of an illustrative example 300 of operation of a stream processor and a pixel processor and includes separation of residual information into multiple channels for decoding. In the example 300, operations are described with respect to a video stream processor (VSP) 302 (e.g., a stream processor), a buffer 320, and a video pixel processor (VPP) 330. In some implementations, the VSP 302, the buffer 320, and the VPP 330 include or correspond to the stream processor 106, the buffer 108, and the pixel processor 114 of FIG. 1, respectively, or to a stream processor, a buffer, and a pixel processor, respectively, of the device 204 of FIG. 2. The example 300 described with reference to FIG. 3 corresponds to decoding image data that is formatted in accordance with particular video encoding schemes, such as the 4:4:4 color format or the 4:2:2 color format. In other examples, the types of residual information and residual data, the number of channels, and the pixel processing and decoding operations performed are different and are based on different types of video encoding schemes, such as H264(AVC), H265(HEVC), H266(VVC), VP9, and AV1, as non-limiting examples.

The VSP 302 is configured to obtain residual information from a bitstream 350, such as by parsing the bitstream 350, and to distribute residual data based on the residual information into multiple residual channels of the buffer 320. As shown in FIG. 3, the VSP 302 includes a parser 304, a header decoder 306, a first residual decoder 308, a second residual decoder 310, and a third residual decoder 312. In other implementations, the VSP 302 may include more, fewer, or different components, such as more than four decoders or fewer than four decoders. In aspects, the parser 304 is configured to parse the bitstream 350 into header information and multiple sets of residual information that are output to the decoders 306-312 for respective decoding. The decoded data from the decoders 306-312 is distributed to respective channels the buffer 320 for eventual processing by the VPP 330. For example, the header decoder 306 is configured to decode header information to generate header data in a header channel 322 of the buffer 320, and the residual decoders 308-312 are each configured to decode a respective portion of the residual information to generate a respective set of residual data in a respective one of the multiple residual channels of the buffer 320. The multiple residual channels include a first residual channel 324, a second residual channel 326, and a third residual channel 328. In some implementations, the first residual channel 324 is configured to buffer luminance residual information, the second residual channel 326 is configured to buffer first chrominance residual information, and the third residual channel 328 is configured to buffer second chrominance residual information. As a particular, non-limiting example, the first chrominance residual information includes Cb residual information, and the second chrominance residual information includes Cr residual information.

The header information, and the header data in the header channel 322, includes or represents characteristics or parameters associated with respective CUs of image frames represented by the bitstream 350. To illustrate, each image frame in the sequence of image frames represented by the bitstream 350 may be divided into one or more respective CUs, and the bitstream 350 may include respective header information and respective residual information associated with each CU. The header information and the header data may include or represent, for a respective CU, a CU size, a prediction, a shape, a motion vector, a TU size, other information related to residual information that corresponds to the CU, or a combination thereof. The residual information, and the residual data in the residual channels 324-328, may include or represent samples (e.g., values) of residual coefficients associated with the respective CU. For example, the residual information and the residual data may include or represent, for each CU, luma coefficient samples associated with the CU, Cb coefficient samples associated with the CU, and Cr coefficient samples associated with the CU.

The VPP 330 is configured to read, in parallel, header data from the header channel 322 and residual data from each of the residual channels 324-328 and, after reading the data from the buffer 320, to process, in parallel, the header data and the residual data to generate representations of image frames encoded in the bitstream 350. As shown in FIG. 3, the VPP 330 includes a header processing unit 332, a first residual pixel processing unit 334, a second residual pixel processing unit 336, a third residual pixel processing unit 338, and optionally, a transfer function 340. In other implementations, the VPP 330 may include more, fewer, or different components, such as more than four processing units or fewer than four processing units. In aspects, the header processing unit 332 is configured to process header data in parallel with the operations of the pixel processing units 334-338, which are each configured to process the residual data of a respective one of the residual channels 324-328 to generate respective pixel data. The processed outputs of the processing units 332-338 are used by the VPP 330 to generate representations of one or more image frames encoded in the bitstream 350. The transfer function 340 includes one or more transfer functions associated with converting a format output by the processing units 332-338 (e.g., images or video) to a format associated with a display device onto which the image frames are to be displayed or played back (e.g., linear light output, or another format, of the display device).

During operation, the VSP 302 obtains the bitstream 350, such as from another device (e.g., the device 102 of FIG. 1) via a network. The bitstream 350 may include a stream header portion 352 that includes header information associated with an entirety of the bitstream 350 and a plurality of component portions, such as an illustrative component portion that includes a component header portion 354 that includes header information associated with the component portion, a first residual component portion 356 (e.g., a luma residual component) that includes first residual information, a second residual component portion 358 (e.g., a Cb residual component) that includes second residual information, and a third residual component portion 359 (e.g., a Cr residual component) that includes third residual information. In some implementations, the residual information is formatted according to a 4:4:4 color format or a 4:2:2 color format. The parser 304 may parse the bitstream 350 into header portions, first residual component portions, second residual component portions, and third residual component portions that are provided to the header decoder 306, the first residual decoder 308, the second residual decoder 310, and the third residual decoder 312, respectively, to decode the respective encoded residual information into respective sets of residual data for distribution to the channels 322-328 of the buffer 320. For example, the header decoder 306 may output a set of header data to the header channel 322, the first residual decoder 308 may output a first set of residual data (e.g., a set of luma residual data) to the first residual channel 324, the second residual decoder 310 may output a second set of residual data (e.g., a set of Cb residual data) to the second residual channel 326, and the third residual decoder 312 may output a third set of residual data (e.g., a set of Cr residual data) to the third residual channel 328. Because of the syntax dependencies and relationships between the three types of residual data and the header in the bitstream 350, configuring the parser 304 to parse the bitstream 350 into the header data and the three channels of residual information may not add significant additional complexity, processing resource usage, or cost, as compared to configuring the parser 304 to parse the bitstream 350 into header information in one channel and all residual information in another channel.

As the header data and the sets of residual data are stored at the buffer 320, the VPP 330 may read the header data and the residual data from the various channels 322-328, in parallel, and provide the data to the respective processing units 332-338 for performance of pixel processing operations to generate representations of image frames 370. For example, the VPP 330 may read stream header data 360 and header data 362 from the header channel 322, first residual data 364 (e.g., luma residual data) from the first residual channel 324, second residual data 366 (e.g., Cb residual data) from the second residual channel 326, and third residual data 368 (e.g., Cr residual data) from the third residual channel 328. The stream header data 360 may be associated with a stream header (e.g., the stream header portion 352), and the header data 362, the first residual data 364, the second residual data 366, and the third residual data 368 may be associated with an image frame encoded in the bitstream 350.

Upon receipt of the data read from the buffer 320, the processing units 332-338 may process the header data 362, the first residual data 364, the second residual data 366, and the third residual data 368, respectively, in parallel to generate a representation of the image frame encoded in the bitstream 350 as one of the image frames 370. For example, the processing units 332-338 may perform one or more prediction operations, one or more transform operations, one or more filter operations, the transfer function 340, or a combination thereof, to process the respective header or residual information in order to generate pixels of one of the image frames 370. The VPP 330 and the processing units 332-338 may perform similar operations of reading data from the channels 322-328 in the buffer 320 and generating additional image frames of the image frames 370 until an entirety of the header and residual data that is generated from the bitstream 350 is processed. In some implementations, the image frames 370 are provided to a display device, such as the display 120 of FIG. 1, for playing out to a user.

The example 300 described above enables decoding of sequences of images (e.g., video) that is encoded according to higher resolution video encoding schemes without increasing decoding speed (e.g., decoding performance) of the VPP 330 as compared to other video processors. To illustrate, other video processors that do not separate the residual data into multiple residual streams and individually buffer each residual channel may be capable of processing approximately 2.67 samples per cycle in an example in which images include 16×16 units. Such processing speeds may support processing of video that is encoded according to the 4:2:0 color format, which in this example includes 384 samples per unit: 256 luma samples, 64 Cb samples, and 64 Cr samples. However, using the same unit size, video that is encoded according to the 4:2:2 color format includes 512 samples per unit: 256 luma samples, 128 Cb samples, and 128 Cr samples, and video that is encoded according to the 4:4:4 color format includes 768 samples per unit: 256 luma samples, 256 Cb samples, and 256 Cr samples. These higher-resolution encoding formats (e.g., the 4:2:2 color format and the 4:4:4 color format) would require greater than 2.67 samples per cycle to be processed by a typical video processor. To illustrate, to process video that is encoded according to the 4:2:0 color format using a typical video processor (e.g., that includes the header processing unit 332 and a single residual pixel processing unit instead of the multiple residual pixel processing units 334-338) that supports processing at 2.67 samples per cycle, processing a 16×16 unit requires 144 cycles (e.g., to process the 384 samples included in the 16×16 unit). However, due to the increased numbers of samples per unit in the 4:2:2 and 4:4:4 color formats, the same video processor that operates at 2.67 samples/cycle would require approximately 1.33 as many cycles (e.g., 192 cycles) or twice as many cycles (e.g., 288 cycles) to process, respectively. To process video that is encoded according to the 4:2:2 or the 4:4:4 color format in the same amount of time (e.g., the same number of cycles) as video that is encoded according to the 4:2:0 color format, the sample throughput of the typical video processor must be increased to 3.55 samples/cycle for the 4:2:2 color format or 5.33 samples/cycle, and thus is expensive and difficult to implement using current video processing technology.

However, with the configuration described above, the VPP 330 processes the three residual streams in parallel, such that a maximum number of decoding cycles per 16×16 unit is 96, at the 2.67 samples/cycle speed, for each of the 4:2:0, 4:2:2, and 4:4:4 color formats. To illustrate, for the 4:2:0 color format, the first residual pixel processing unit 334 processes 256 samples per 16×16 unit in 96 cycles, the second residual pixel processing unit 336 processes 64 samples per 16×16 unit in 24 cycles, and the third residual pixel processing unit 338 processes 64 samples per 16×16 unit in 24 cycles. For the 4:2:2 color format, the first residual pixel processing unit 334 processes 256 samples per 16×16 unit in 96 cycles, the second residual pixel processing unit 336 processes 128 samples per 16×16 unit in 48 cycles, and the third residual pixel processing unit 338 processes 128 samples per 16×16 unit in 48 cycles. For the 4:4:4 color format, the first residual pixel processing unit 334 processes 256 samples per 16×16 unit in 96 cycles, the second residual pixel processing unit 336 processes 256 samples per 16×16 unit in 96 cycles, and the third residual pixel processing unit 338 processes 256 samples per 16×16 unit in 96 cycles. Accordingly, the VPP 330 is capable of processing video encoded according to the 4:2:2 or the 4:4:4 color format in the same amount of time (e.g., number of cycles) as video that is encoded according to the 4:2:0 color format, without the expense and difficulty associated with increasing the sample throughput of the VPP 330 (e.g., the residual pixel processing units 334-338). Additionally, the VPP 330 is capable of processing video encoded to any of the three color formats faster than the typical video processor. For example, compared to typical video processors that do not distribute residual data into multiple channels for parallel processing, the processing speed of VPP 330 may be increased by 1.5× for the 4:2:0 color format, by 2× for the 4:2:2 color format, and by 3× for the 4:4:4 color format. Thus, the VPP 330 is capable of supporting higher resolution video formats without increasing the decoding speed (e.g., in samples/cycle) of the VPP 330 and without introducing delay to a viewer of the image frames 370.

FIG. 4 is a diagram of an illustrative example 400 of operation of a stream processor and a pixel processor and includes separation of residual information into multiple channels for encoding. In the example 400, operations are described with respect to a video stream processor (VSP) 402 (e.g., a stream processor), a buffer 420, and a video pixel processor (VPP) 430. In some implementations, the VSP 402, the buffer 420, and the VPP 430 include or correspond to the stream processor 206, the buffer 208, and the pixel processor 214 of FIG. 2, respectively, or to a stream processor, a buffer, and a pixel processor, respectively, of the device 102 of FIG. 1. The example 400 described with reference to FIG. 4 corresponds to encoding image data according to particular video encoding schemes, such as the 4:4:4 color format or the 4:2:2 color format. In other examples, the types of residual information and residual data, the number of channels, and the pixel processing and decoding operations performed are different and are based on different types of video encoding schemes, such as H264(AVC), H265(HEVC), H266(VVC), VP9, and AV1, as non-limiting examples.

The VPP 430 is configured to obtain image frames 470, such as a sequence of image frames (e.g., video), and to perform pixel processing operations on the image frames 470 to generate, in parallel, header data and residual data that is distributed to channels at the buffer 420. As shown in FIG. 4, the VPP 430 includes a header processing unit 432, a first residual pixel processing unit 434, a second residual pixel processing unit 436, a third residual pixel processing unit 438, and optionally, a transfer function 440. In other implementations, the VPP 430 may include more, fewer, or different components, such as more than four processing units or fewer than four processing units. In aspects that include the transfer function 440, the transfer function 440 includes one or more transfer functions associated with converting a format output by a camera or other device from which the image frames 470 are obtained (e.g., scene light, linear light output, or another format) to a format for being processed by the VPP 430 (e.g., images or video). In aspects, the header processing unit 432 is configured to perform pixel processing on an image frame (e.g., one of the image frames 470, after performance of the transfer function 440) to generate header data in parallel with the operations of the residual pixel processing units 434-438, which are each configured to perform pixel processing operations on the image frame to generate respective residual data. The sets of header data and residual data that are output by the processing units 432-438 are distributed to respective channels of the buffer 420. For example, the header processing unit 432 is configured to perform pixel processing on image frames to generate header data in a header channel 422 of the buffer 420, and each of the residual pixel processing units 434-438 is configured to perform pixel processing on the image frames to generate a respective set of residual data in a respective one of multiple residual channels of the buffer 420. The multiple residual channels include a first residual channel 424, a second residual channel 426, and a third residual channel 428. In some implementations, the first residual channel 424 is configured to buffer luminance residual information, the second residual channel 426 is configured to buffer first chrominance residual information, and the third residual channel 428 is configured to buffer second chrominance residual information. As a particular, non-limiting example, the first chrominance residual information includes Cb residual information, and the second chrominance residual information includes Cr residual information.

The header information, and the header data in the header channel 422, includes or represents characteristics or parameters associated with respective CUs of the image frames 470. To illustrate, each image frame of the image frames 470 may be divided into one or more respective CUs, and the VPP 430 may process the image frames 470 as a sequence of CUs to generate the respective header information and residual information associated with each CU. The header information and the header data may include or represent, for a respective CU, a CU size, a prediction, a shape, a motion vector, a TU size, other information related to residual information that corresponds to the CU, or a combination thereof. The residual information and the residual data may include or represent samples (e.g., values) of respective residual coefficients associated with the respective CU. For example, the residual information and the residual data may include or represent, for each CU, luma coefficient samples associated with the CU, Cb coefficient samples associated with the CU, and Cr coefficient samples associated with the CU.

The VSP 402 is configured to read, in parallel, header data from the header channel 422 and residual data from each of the residual channels 424-428, and to encode, in parallel, the data read from the buffer 420 to generate a bitstream 450. As shown in FIG. 4, the VSP 402 includes a header encoder 406, a first residual encoder 408, a second residual encoder 410, a third residual encoder 412, and a combiner 404. In other implementations, the VSP 402 may include more, fewer, or different components, such as more than four encoders or fewer than four encoders. In aspects, the header encoder 406 is configured to encode header data 462 in parallel with the operations of the residual encoders 408-412, which are each configured to encode the residual data of a respective one of the residual channels 424-428. The output of the encoders 406-412 are provided to the combiner 404, which combines and encodes the processed data to generate the bitstream 450.

During operation, the VPP 430 obtains the image frames 470, such as from a camera (e.g., the camera 220 of FIG. 2) or another device. The VPP 430 may provide the image frames 470 serially, after optionally being transformed by the transfer function 440, to the header processing unit 432, the first residual pixel processing unit 434, the second residual pixel processing unit 436, and the third residual pixel processing unit 438 to perform pixel processing, in parallel, on an image frame (of the image frames 470) to generate header data and respective residual data for distribution to the header channel 422 and the residual channels 424-428 of the buffer 420. For example, the header processing unit 432 may output a set of header data to the header channel 422, the first residual pixel processing unit 434 may output a first set of residual data (e.g., a set of luma residual data) to the first residual channel 424, the second residual pixel processing unit 436 may output a second set of residual data (e.g., a set of Cb residual data) to the second residual channel 426, and the third residual pixel processing unit 438 may output a third set of residual data (e.g., a set of Cr residual data) to the third residual channel 428.

As the header data and the sets of residual data are stored at the buffer 420, the VSP 402 may read the header data and the residual data from the various channels 422-428, in parallel, and provide the data to the encoders 406-412 for encoding, and then combining at the combiner 404, to generate representations the bitstream 350 that is an encoded representation of image frames 470. For example, the VSP 402 may read header data 462 from the header channel 422, first residual data 464 (e.g., luma residual data) from the first residual channel 424, second residual data 466 (e.g., Cb residual data) from the second residual channel 426, and third residual data 468 (e.g., Cr residual data) from the third residual channel 428. The header data 462, the first residual data 464, the second residual data 466, and the third residual data 468 may be associated with one of the image frames 470 (e.g., a first image frame).

Upon receipt of the data read from the buffer 420, the encoders 406-412 may encode the header data 462, the first residual data 464, the second residual data 466, and the third residual data 468, respectively, in parallel to generate respective residual information (e.g., coded residual data) that is combined, at the combiner 404, to generate a portion of the bitstream 450 (e.g., a portion that corresponds to the first image frame). For example, the encoders 406-412 and the combiner 404 may perform operations that generate of a component portion of the bitstream 450, such as an illustrative component portion that includes a component header portion 454 that includes header information associated with the component portion, a first residual component portion 456 (e.g., a luma residual component) that includes first residual information, a second residual component portion 458 (e.g., a Cb residual component) that includes second residual information, and a third residual component portion 459 (e.g., a Cr residual component) that includes third residual information. In some implementations, the residual information is formatted according to the 4:4:4 color format or the 4:2:2 color format. The encoders 406-412 and the combiner 404 may perform similar operations of reading data from the channels 422-428 in the buffer 420 and generating additional portions of the bitstream 450 until an entirety of the header and residual data that is generated from the image frames 470 is processed. During this process, the VSP 402 may also generate a stream header portion 452 of the bitstream 450. In some implementations, the bitstream 450 is sent to another device, such as the device 204 of FIG. 2, via a network.

The example 400 described above enables encoding of sequences of images (e.g., video) according to higher resolution video encoding schemes without increasing encoding speed (e.g., decoding performance) of the VPP 430 as compared to other video processors. Similar to as explained above with reference to FIG. 3, with the configuration described above, the VPP 430 generates the three residual streams in parallel, such that a maximum number of encoding cycles per 16×16 unit is 96, at the 2.67 samples/cycle speed, for each of the 4:2:0, 4:2:2, and 4:4:4 color formats. Accordingly, the VPP 430 processes video at 1.5×, 2×, or 3× the speed of a typical video processor for the 4:2:0 color format, the 4:2:2 color format, and the 4:4:4 color format, respectively, without requiring increased sample throughput at the VPP 430 (e.g., at the residual pixel processing units 434-438). Thus, the VPP 430 is capable of supporting higher resolution video formats without increasing the encoding speed (e.g., in samples/cycle) of the VPP 430 and without introducing delay to transmission of the bitstream 450.

FIG. 5 is a diagram of an example of a system 500 that includes an integrated circuit 502 operable to separate residual information into multiple channels for decoding or encoding, in accordance with some examples of the present disclosure. The integrated circuit 502 may include or correspond, or be integrated within, the device 104, the device 202, or both. The integrated circuit 502 includes one or more processors 590 (e.g., a system-on-chip). In some implementations, the one or more processors 590 include the stream processor 106, the pixel processor 114, the stream processor 206, the pixel processor 214, or a combination thereof. In some implementations, the one or more processors 590 include on-chip memory 532 that includes the buffer 108, the buffer 208, or both.

The integrated circuit 502 also includes a signal input 504, such as one or more bus interfaces, to enable input data 528 to be received for processing. The integrated circuit 502 also includes a signal output 506, such as a bus interface, to enable sending of output data 550. In some implementations, the input data 528 includes the bitstream 130 and the output data 550 includes the image frames 140. In some implementations, the input data 528 includes the image frames 240 and the output data 550 includes the bitstream 230.

The integrated circuit 502 enables implementation of separating residual information into multiple channels for decoding or encoding as a component in a system that includes a camera, a display, or both, such as a mobile phone or tablet as depicted in FIG. 6, a wearable electronic device as depicted in FIG. 7, augmented reality or mixed reality glasses as depicted in FIG. 8, a voice-controlled speaker system as depicted in FIG. 9, a camera as depicted in FIG. 10, a virtual reality, mixed reality, or augmented reality headset as depicted in FIG. 11, or a vehicle as depicted in FIG. 12 or FIG. 13.

FIG. 6 is a diagram of an illustrative aspect of a system 600 that includes a mobile device 602 operable to separate residual information into multiple channels for decoding or encoding, in accordance with some examples of the present disclosure. The mobile device 602, such as a phone or tablet, as illustrative, non-limiting examples, may include or correspond to the device 104, the device 202, or both. The mobile device 602 includes the display 120 (e.g., a display screen) and one or more of the camera 220. Components of the processor 590, including the stream processor 106, the pixel processor 114, the stream processor 206, the pixel processor 214, the on-chip memory 532, or a combination thereof, are integrated in the mobile device 602 and are illustrated using dashed lines to indicate internal components that are not generally visible to a user of the mobile device 602. In a particular example, the mobile device 602 operates to detect a user input to display a video received as the bitstream 130 from another device, which causes the mobile device 602 to decode and process the bitstream 130 to generate the image frames 140 that are provided to the display 120. In another example, the mobile device 602, in response to a user input to record and send a video to another device, encodes the image frames 240 from the camera 220 to generate the bitstream 230 that is sent to another device.

FIG. 7 is a diagram of an illustrative aspect of a system 700 that includes a wearable electronic device 702 operable to separate residual information into multiple channels for decoding or encoding, in accordance with some examples of the present disclosure. The wearable electronic device 702, illustrated as a “smart watch” in FIG. 7, may include or correspond to the device 104, the device 202, or both. Components of the processor 590, including the stream processor 106, the pixel processor 114, the stream processor 206, the pixel processor 214, the on-chip memory 532, or a combination thereof, and one or more of the camera 220 are integrated into the wearable electronic device 702. In a particular example, the wearable electronic device 702 operates to detect user input, which is then processed to perform one or more operations at the wearable electronic device 702, such as encoding image frames or decoding a bitstream. To illustrate, the wearable electronic device 702, in response to receiving a user input to transmit camera output to another device, encodes the image frames 240 from the camera 220 to generate the bitstream 230 for transmission to another device. In another example, the wearable electronic device 702, in response to a user input to display a video received from another device, decodes the bitstream 130 from the other device and provides the image frames 140 to the display 120.

In a particular example, the wearable electronic device 702 includes a haptic device that provides a haptic notification (e.g., vibrates) in response to detection of user voice activity. For example, the haptic notification can cause a user to look at the wearable electronic device 702 to see a displayed notification indicating that output of the camera 220 is being encoded and transmitted or that image frames 140 are decoded and available for viewing.

FIG. 8 is a diagram of an illustrative aspect of a system 800 that includes augmented reality or mixed reality glasses 802 operable to separate residual information into multiple channels for decoding or encoding, in accordance with some examples of the present disclosure. The glasses 802 may include or correspond to the device 104, the device 202, or both. The glasses 802 include a holographic projection unit 804 configured to project visual data onto a surface of a lens 806 or to reflect the visual data off of a surface of the lens 806 and onto the wearer's retina. In a particular aspect, the lens 806 corresponds to the display 120 of FIG. 1. Components of the processor 590, including the stream processor 106, the pixel processor 114, the stream processor 206, the pixel processor 214, the on-chip memory 532, or a combination thereof, and one or more of the camera 220 are integrated into the glasses 802. The pixel processor 214 and the stream processor 206 may function to generate the bitstream 230 based on image frames received from the camera 220. In a particular example, the holographic projection unit 804 is configured to display a notification indicating that camera output is being transmitted to another device after generation of the bitstream 230. In another example, the holographic projection unit 804 is configured to display a notification indicating that the image frames 140 have been decoded from the bitstream 130 (e.g., from another device) and are available for viewing.

FIG. 9 is a diagram of an illustrative aspect of a system 900 that includes a wireless speaker and voice-activated device 902 operable to separate residual information into multiple channels for decoding or encoding, in accordance with some examples of the present disclosure. The wireless speaker and voice-activated device 902 may include or correspond to the device 104, the device 202, or both. The wireless speaker and voice-activated device 902 can have wireless network connectivity and is configured to execute an assistant operation. Components of the processor 590, including the stream processor 106, the pixel processor 114, the stream processor 206, the pixel processor 214, the on-chip memory 532, or a combination thereof, and one or more of the camera 220 are included in the wireless speaker and voice-activated device 902. The wireless speaker and voice-activated device 902 also includes the display 120 (e.g., a display screen), a speaker 904 and one or more microphones 920. During operation, in response to receiving a verbal command identified as user speech, the wireless speaker and voice-activated device 902 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”). In some examples, the assistant operations can include generating the bitstream 230 from camera output of the camera 220 for transmission to another device, generating the image frames 140 from bitstream 130 received from another device for viewing on the display 120, or both.

FIG. 10 is a diagram of an illustrative aspect of a system 1000 that includes a camera device 1002 operable to separate residual information into multiple channels for decoding or encoding, in accordance with some examples of the present disclosure. The camera device 1002 may include the device 104, the device 202, or both. Components of the processor 590, including the stream processor 106, the pixel processor 114, the stream processor 206, the pixel processor 214, the on-chip memory 532, or a combination thereof, are included in the camera device 1002. The camera device 1002 includes an image sensor 1020 corresponding to the camera 220 of FIG. 2. During operation, in response to receiving a user input, the camera device 1002 can execute operations responsive to user commands, such as to adjust image or video capture settings, image or video playback settings, or image or video capture instructions, as illustrative examples. In some examples, the camera device 1002 can generate the bitstream 230 from output of the image sensor 1020 for transmission to another device, generate the image frames 140 from the bitstream 130 received from another device for viewing on a display (not shown), or both.

FIG. 11 is a diagram of an illustrative aspect of a system 1100 that includes a headset device 1102, such as a virtual reality, mixed reality, or augmented reality headset, operable to separate residual information into multiple channels for decoding or encoding, in accordance with some examples of the present disclosure. The headset device 1102 may include or correspond to the device 104, the device 202, or both. Components of the processor 590, including the stream processor 106, the pixel processor 114, the stream processor 206, the pixel processor 214, the on-chip memory 532, or a combination thereof, and one or more of the camera 220 are integrated into the headset device 1102. In a particular aspect, the headset device 1102 can perform user voice activity detection based on audio signals received from a microphone 1120 of the headset device 1102. A visual interface device is positioned in front of the user's eyes to enable display of augmented reality, mixed reality, or virtual reality images or scenes to the user while the headset device 1102 is worn. In a particular example, the visual interface device is configured to display a notification indicating that camera output from the camera 220 is being encoded into the bitstream 230 and transmitted to another device. In another particular example, the visual interface device is configured to display the image frames 140 generated from decoding the bitstream 130 received from another device.

FIG. 12 is a diagram of a first example of a system 1200 that includes a vehicle 1202 operable to separate residual information into multiple channels for decoding or encoding, in accordance with some examples of the present disclosure. The vehicle 1202, illustrated as a manned or unmanned aerial device (e.g., a package delivery drone) in FIG. 12, may include or correspond to the device 104, the device 202, or both. Components of the processor 590, including the stream processor 106, the pixel processor 114, the stream processor 206, the pixel processor 214, the on-chip memory 532, or a combination thereof, and one or more of the camera 220 are integrated into the vehicle 1202. In a particular example, the vehicle 1202 generates the bitstream 230 from encoding the image frames 240 received from the camera 220 for storage, transmission, or both. In another particular example, the vehicle 1202 generates the image frames 140 from decoding the bitstream 130 received from another device and provides the image frames 140 to a display screen (not shown) for viewing by a user (e.g., a recipient of a package).

FIG. 13 is a diagram of a second example of a system 1300 that includes a vehicle 1302 operable to separate residual information into multiple channels for decoding or encoding, in accordance with some examples of the present disclosure. The vehicle 1302, illustrated as a car in FIG. 13, can include or correspond to the device 104, the device 202, or both. Although the vehicle 1302 is depicted as a car, in other implementations, the vehicle 1302 may be another type of vehicle, such as an aerial vehicle (e.g., an airplane). The vehicle 1302 includes components of the processor 590, including the stream processor 106, the pixel processor 114, the stream processor 206, the pixel processor 214, the on-chip memory 532, or a combination thereof. The vehicle 1302 also includes one or more of the camera 220, one or more microphones 1320, and the display 120 (e.g., a display screen). User voice activity detection can be performed based on audio signals received from the microphone(s) 1320 of the vehicle 1302. In some implementations, user voice activity detection can be performed based on an audio signal received from interior microphones (e.g., the microphone(s) 1320), such as for a voice command from an authorized passenger. For example, the user voice activity detection can be used to detect a voice command from an operator of the vehicle 1302 (e.g., from a parent to set a volume to 5 or to set a destination for a self-driving vehicle) and to disregard the voice of another passenger (e.g., a voice command from a child to set the volume to 10 or other passengers discussing another location). In some implementations, user voice activity detection can be performed based on an audio signal received from external microphones (e.g., the microphone(s) 1320), such as an authorized user of the vehicle 1302. In a particular implementation, in response to receiving a verbal command identified as user speech, a voice activation system initiates one or more operations of the vehicle 1302 based on one or more keywords (e.g., “unlock,” “start engine,” “play music,” “display weather forecast,” or another voice command) detected in a microphone output signal, such as by providing feedback or information via the display 120 or one or more speakers.

In a particular example, the vehicle 1302 generates the bitstream 230 from encoding the image frames 240 received from the camera 220 for storage, transmission, or both. In another particular example, the vehicle 1302 generates the image frames 140 from decoding the bitstream 130 received from another device and provides the image frames 140 to the display 120 for viewing by a passenger.

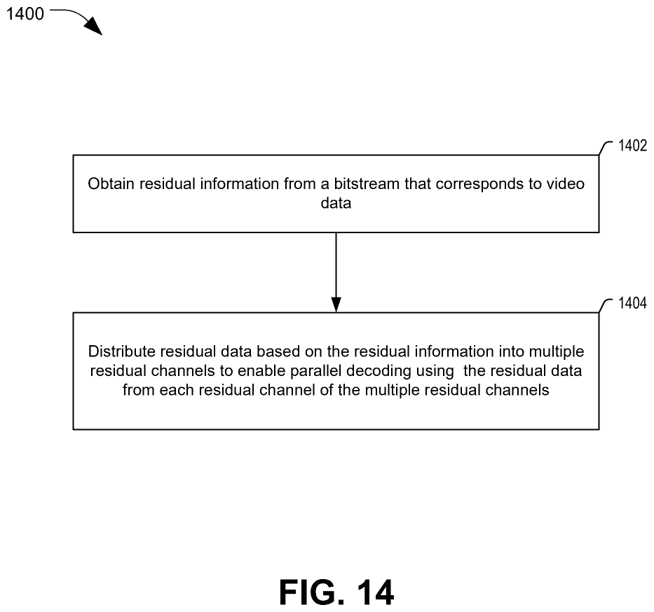

Referring to FIG. 14, a particular implementation of a method 1400 of separating residual information into multiple channels for decoding, in accordance with some examples of the present disclosure, is shown. The method 1400 may be performed by the device 102, the device 104, the device 202, the device 204, the VSP 302, the buffer 320, the VPP 330, the VSP 402, the buffer 420, the VPP 430, the integrated circuit 502, the mobile device 602, the wearable electronic device 702, the glasses 802, the wireless speaker and voice-activated device 902, the camera device 1002, the headset device 1102, the vehicle 1202, the vehicle 1302, or another device, as illustrative, non-limiting examples. In a particular aspect, one or more operations of the method 1400 are performed by at least one of the stream processor 106, the pixel processor 114, the buffer 108, the device 104, the system 100 of FIG. 1, the VSP 302, the buffer 320, the VPP 330 of FIG. 3, or a combination thereof.

The method 1400 includes obtaining residual information from a bitstream that corresponds to video data, at block 1402. For example, the bitstream may include or correspond to the bitstream 130 of FIG. 1, which is obtained by the stream processor 106 and parsed and decoded into header information and residual information. The method 1400 also includes distributing residual data based on the residual information into multiple residual channels to enable parallel decoding using the residual data from each residual channel of the multiple residual channels, at block 1404. For example, the stream processor 106 may further parse and decode the residual information into the sets of residual data 132-134 that are each distributed to a respective channel of the residual channels 110-112 of FIG. 1. Additionally, the pixel processor 114 reads and processes respective residual data from each of the residual channels to perform parallel processing. For example, the pixel processor 114 may read the residual data 136-138 of FIG. 1 from the residual channels 110-112 and perform parallel processing on the residual data 136-138 (e.g., process the residual data 136-138 during concurrent or overlapping time periods).

In some implementations, the method 1400 also includes parsing the bitstream to generate the residual information. The residual information includes luminance residual information, first chrominance residual information, and second chrominance residual information. In such implementations, distributing the residual data includes distributing a first set of residual data that is based on the luminance residual information to a first residual channel of the multiple residual channels, distributing a second set of residual data that is based on the first chrominance residual information to a second residual channel of the multiple residual channels, and distributing a third set of residual data that is based on the second chrominance residual information to a third residual channel of the multiple residual channels. For example, the first set of residual data may include or correspond to the residual data stored in the first residual channel 324 of FIG. 3, the second set of residual data may include or correspond to the residual data stored in the second residual channel 326 of FIG. 3, and the third set of residual data may include or correspond to the residual data stored in the third residual channel 328 of FIG. 3.

In some such implementations in which the residual information includes the luminance residual information, the first chrominance residual information, and the second chrominance residual information, the method 1400 further includes reading, in parallel, first residual data from the first residual channel, second residual data from the second residual channel, and third residual data from the third residual channel. The method 1400 also includes performing, in parallel, pixel processing operations on the first residual data, the second residual data, and the third residual data, to generate a representation of an image frame. For example, the first residual pixel processing unit 334 of FIG. 3 may perform pixel processing operations on residual data from the first residual channel 324 in parallel with the second residual pixel processing unit 336 performing pixel processing operations on residual data from the second residual channel 326 and the third residual pixel processing unit 338 performing pixel processing operations on residual data from the third residual channel 328 to generate the image frames 370.

The method 1400 thus enables the technical advantage of increasing the amount of residual information that can be decoded and processed to generate image frames without increasing the decoding speed (e.g., decoding performance) of a pixel processor or incurring a delay in the playback of the image frames, as compared to other devices that decode bitstream data to generate image frames. This enables support of higher resolution encoding formats without significantly increasing processing resource usage and power consumption.

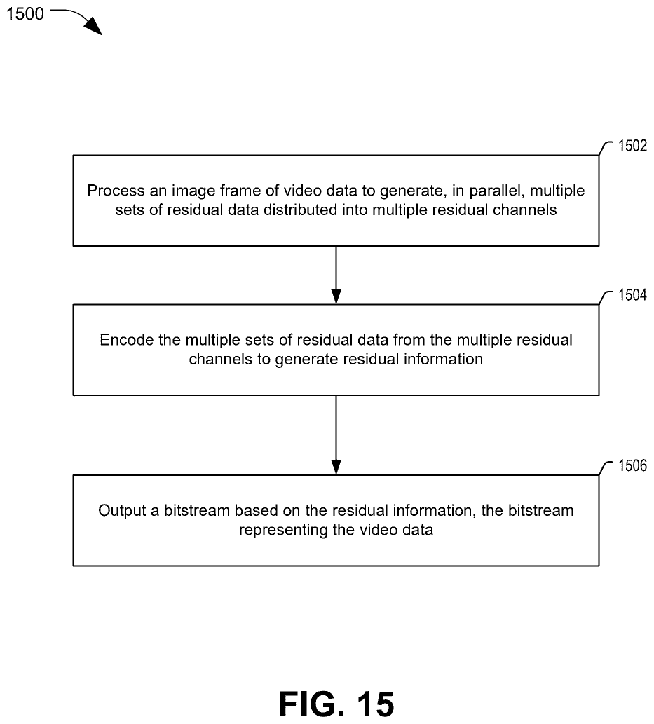

Referring to FIG. 15, a particular implementation of a method 1500 of separating residual information into multiple channels for encoding, in accordance with some examples of the present disclosure, is shown. The method 1500 may be performed by the device 102, the device 104, the device 202, the device 204, the VSP 302, the buffer 320, the VPP 330, the VSP 402, the buffer 420, the VPP 430, the integrated circuit 502, the mobile device 602, the wearable electronic device 702, the glasses 802, the wireless speaker and voice-activated device 902, the camera device 1002, the headset device 1102, the vehicle 1202, the vehicle 1302, or another device, as illustrative, non-limiting examples. In a particular aspect, one or more operations of the method 1500 are performed by at least one of the stream processor 206, the pixel processor 214, the buffer 208, the device 204, the system 200 of FIG. 2, the VSP 402, the buffer 420, the VPP 430, or a combination thereof.

The method 1500 includes processing an image frame of video data to generate, in parallel, multiple sets of residual data distributed into multiple residual channels, at block 1502. For example, the image frame may include or correspond to one of the image frames 240 of FIG. 2, the multiple sets of residual data may include or correspond to the residual data 236-238 of FIG. 2, and the multiple residual channels may include or correspond to the residual channels 210-212 of FIG. 2.

The method 1500 also includes encoding the multiple sets of residual data from the multiple residual channels to generate residual information, at block 1504. For example, the multiple sets of residual information may be generated based on the sets of residual data 232-234 of FIG. 2. The method 1500 further includes outputting a bitstream based on the residual information. The bitstream represents the video data, at block 1506. For example, the bitstream may include or correspond to the bitstream 230 of FIG. 2.

In some implementations, processing the image frame includes processing the image frame to generate luminance residual data in a first residual channel of the multiple residual channels, processing the image frame to generate first chrominance residual data in a second residual channel of the multiple residual channels, and processing the image frame to generate second chrominance residual data in a third residual channel of the multiple residual channels. For example, the luminance data may include or correspond to the first residual data buffered in the first residual channel 424 of FIG. 4, the first chrominance data may include or correspond to the second residual data buffered in the second residual channel 426 of FIG. 4, and the second chrominance data may include or correspond to the third residual data buffered in the third residual channel 428 of FIG. 4.

In some such implementations in which processing the image frame generates luminance residual data, first chrominance residual data, and second chrominance residual data, encoding the multiple sets of residual data includes encoding the luminance residual data to generate luminance residual information, encoding the first chrominance residual data to generate first chrominance residual information, encoding the second chrominance residual data to generate second chrominance residual information, and combining the luminance residual information, the first chrominance residual information, and the second chrominance residual information to generate the residual information. For example, the header encoder 406 of FIG. 4 may encode the first residual data from the first residual channel 424 in parallel with the second residual encoder 410 encoding the second residual data from the second residual channel 426 and the third residual encoder 412 encoding the third residual data from the third residual channel 428 to generate encoded data that is combined by the combiner 404 to generate the bitstream 450.

The method 1500 thus enables the technical advantage of increasing the amount of residual information that can be encoded and processed to generate a bitstream that represents image frames without increasing the encoding speed (e.g., encoding performance) of a pixel processor, as compared to other devices that encode a sequence of image frames to generate a bitstream. This enables support of higher resolution encoding formats without significantly increasing processing resource usage and power consumption.

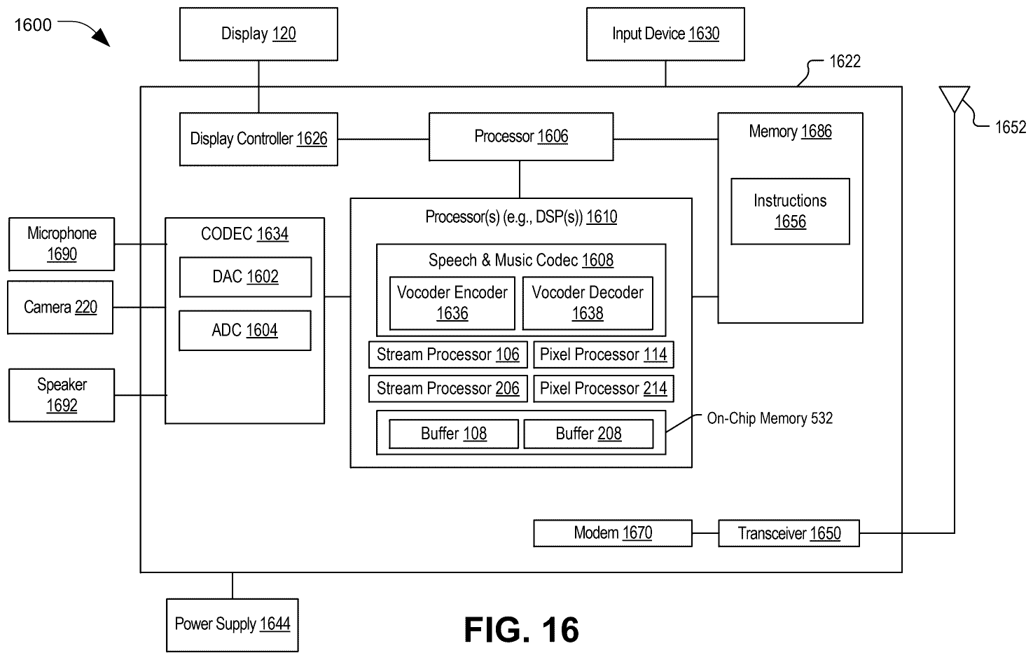

The method 1400 of FIG. 14, the method 1500 of FIG. 15, or both, may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1400 of FIG. 14, the method 1500 of FIG. 15, or both, may be performed by one or more processors that execute instructions, such as described with reference to FIG. 16.

Referring to FIG. 16, a block diagram of a particular illustrative implementation of a device 1600 that is operable to separate residual information into multiple channels for decoding or encoding, in accordance with some examples of the present disclosure, is depicted. In various implementations, the device 1600 may have more or fewer components than illustrated in FIG. 16. In an illustrative implementation, the device 1600 may correspond to the device 104, the device 202, or both. In an illustrative implementation, the device 1600 may perform one or more operations described with reference to FIGS. 1-15.

In a particular implementation, the device 1600 includes a processor 1606 (e.g., a central processing unit (CPU)). The device 1600 may include one or more additional processors 1610 (e.g., one or more DSPs). In a particular aspect, the processor 590 of FIG. 5 corresponds to the processor 1606, the processors 1610, or a combination thereof. The processors 1610 may include a speech and music coder-decoder (CODEC) 1608 that includes a voice coder (“vocoder”) encoder 1636, a vocoder decoder 1638, or a combination thereof. The processors 1610 include the stream processor 106, the pixel processor 114, the stream processor 206, the pixel processor 214, the on-chip memory 532, or a combination thereof.

In FIG. 16, the device 1600 includes a memory 1686 and a CODEC 1634. The memory 1686 includes (e.g., stores) instructions 1656, that are executable by the one or more processors 1610 (or the processor 1606) to implement the functionality described with reference to the stream processor 106, the buffer 108, the pixel processor 114, the stream processor 206, the buffer 208, the pixel processor 214, the VSP 302, the buffer 320, the VPP 330, the VSP 402, the buffer 420, the VPP 430, or a combination thereof.

In FIG. 16, the device 1600 also includes a modem 1670 coupled, via a transceiver 1650, to an antenna 1652. The modem 1670, the transceiver 1650, and the antenna 1652 enable the device 1600 to exchange data with one or more other devices via wireless communications. For example, in some implementations, the device 1600 can generate the bitstream 230 for wireless communication to another device. In some implementations, the modem 1670 is coupled to the one or more processors 1610 or the processor 1606. The modem 1670 may be configured to receive the bitstream 130 from another device via wireless communication.

The device 1600 may include the display 120 coupled to a display controller 1626. A speaker 1692, a microphone 1690, and a camera 220 may be coupled to the CODEC 1634. The CODEC 1634 may include a digital-to-analog converter (DAC) 1602, an analog-to-digital converter (ADC) 1604, or both. In a particular implementation, the CODEC 1634 may receive analog signals from the microphone 1690, convert the analog signals to digital signals using the ADC 1604, and provide the digital signals to the speech and music codec 1608. The speech and music codec 1608 may process the digital signals. In a particular implementation, the speech and music codec 1608 may provide digital signals to the CODEC 1634. The CODEC 1634 may convert the digital signals to analog signals using the DAC 1602 and may provide the analog signals to the speaker 1692. In a particular implementation, the CODEC 1634 may receive analog signals from the camera 220, convert the analog signals to digital signals using the ADC 1604, and provide the digital signals to the pixel processor 214.

In a particular implementation, the device 1600 may be included in a system-in-package or system-on-chip device 1622. In a particular implementation, the memory 1686, the processor 1606, the processors 1610, the display controller 1626, the CODEC 1634, and the modem 1670 are included in the system-in-package or system-on-chip device 1622. In a particular implementation, an input device 1630 and a power supply 1644 are coupled to the system-in-package or the system-on-chip device 1622. Moreover, in a particular implementation, as illustrated in FIG. 16, the display 120, the input device 1630, the speaker 1692, the microphone 1690, the camera 220, the antenna 1652, and the power supply 1644 are external to the system-in-package or the system-on-chip device 1622. In a particular implementation, each of the display 120, the input device 1630, the speaker 1692, the microphone 1690, the antenna 1652, and the power supply 1644 may be coupled to a component of the system-in-package or the system-on-chip device 1622, such as an interface or a controller.

The device 1600 may include or correspond to a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining residual information from a bitstream that corresponds to video data. For example, the means for obtaining can correspond to the stream processor 106, the device 104, the system 100 of FIG. 1, the device 204 of FIG. 2, the VSP 302 of FIG. 3, the processor 1606, the processors 1610, the device 1600 of FIG. 16, one or more other circuits or components configured to obtain residual information from a bitstream, or any combination thereof.

The apparatus also includes means for distributing residual data based on the residual information into multiple residual channels to enable parallel decoding using the residual data from each residual channel of the multiple residual channels. For example, the means for distributing can correspond to the stream processor 106, the device 104, the system 100 of FIG. 1, the device 204 of FIG. 2, the VSP 302 of FIG. 3, the processor 1606, the processors 1610, the device 1600 of FIG. 16, one or more other circuits or components configured to distribute residual data into multiple residual channels, or any combination thereof.

In conjunction with the described implementations, an apparatus includes means for processing an image frame of video data to generate, in parallel, multiple sets of residual data distributed into multiple residual channels. For example, the means for processing can correspond to the device 102 of FIG. 1, the pixel processor 214, the device 202, the system 200 of FIG. 2, the VPP 430, the header processing unit 432, the first residual pixel processing unit 434, the second residual pixel processing unit 436, the third residual pixel processing unit 438 of FIG. 4, the processor 1606, the processors 1610, the device 1600 of FIG. 16, one or more other circuits or components configured to process an image frame of video data to generate, in parallel, multiple sets of residual data, or any combination thereof.

The apparatus also includes means for encoding the multiple sets of residual data from the multiple residual channels to generate residual information. For example, the means for encoding can correspond to the device 102 of FIG. 1, the stream processor 206, the device 202, the system 200 of FIG. 2, the VSP 402, the header encoder 406, the first residual encoder 408, the second residual encoder 410, the third residual encoder 412 of FIG. 4, the processor 1606, the processors 1610, the device 1600 of FIG. 16, one or more other circuits or components configured to encode multiple sets of residual data to generate residual information, or any combination thereof.

The apparatus further includes means for outputting a bitstream based on the residual information, the bitstream representing the video data. For example, the means for outputting can correspond to the device 102 of FIG. 1, the stream processor 206, the device 202, the system 200 of FIG. 2, the VSP 402, the combiner 404 of FIG. 4, the processor 1606, the processors 1610, the device 1600 of FIG. 16, one or more other circuits or components configured to output a bitstream based on residual information, or any combination thereof.

In some implementations, a non-transitory, computer-readable medium (e.g., a computer-readable storage device, such as the memory 1686) stores instructions (e.g., the instructions 1656) that, when executed by one or more processors (e.g., the one or more processors 590, the one or more processors 1610, or the processor 1606), cause the one or more processors to obtain residual information from a bitstream that corresponds to video data. The instructions, when executed by the processor, also cause the processor to distribute residual data based on the residual information into multiple residual channels to enable parallel decoding using the residual data from each residual channel of the multiple residual channels.

In some implementations, a non-transitory, computer-readable medium (e.g., a computer-readable storage device, such as the memory 1686) stores instructions (e.g., the instructions 1656) that, when executed by one or more processors (e.g., the one or more processors 590, the one or more processors 1610, or the processor 1606), cause the one or more processors to process an image frame of video data to generate, in parallel, multiple sets of residual data distributed into multiple residual channels. The instructions, when executed by the processor, also cause the processor to encode the multiple sets of residual data from the multiple residual channels to generate residual information. The instructions, when executed by the processor, further cause the processor to output a bitstream based on the residual information, the bitstream representing the video data.

Particular aspects of the disclosure are described below in sets of interrelated Examples:

According to Example 1, a device includes a memory configured to store a bitstream corresponding to video data; and one or more processors coupled to the memory, wherein the one or more processors are configured to: obtain residual information from the bitstream; and distribute residual data based on the residual information into multiple residual channels to enable parallel decoding using the residual data from each residual channel of the multiple residual channels.

Example 2 includes the device of Example 1, wherein the multiple residual channels include a first residual channel for luminance residual information, a second residual channel for first chrominance residual information, and a third residual channel for second chrominance residual information.

Example 3 includes the device of Example 1 or Example 2, wherein the one or more processors include a video stream processor (VSP) coupled to a buffer, and wherein the VSP is configured to parse the bitstream and to distribute the residual data as multiple sets of residual data into the multiple residual channels at the buffer.

Example 4 includes the device of Example 3, wherein the VSP includes: a parser configured to parse the bitstream to generate header information and the residual information; a header decoder configured to decode the header information to generate header data in a header channel of the buffer; and multiple residual decoders, each of the multiple residual decoders configured to decode a respective portion of the residual information to generate a respective set of residual data in a respective one of the multiple residual channels at the buffer.

Example 5 includes the device of Example 4, wherein the one or more processors further include a video pixel processor (VPP) configured to read, in parallel, a respective set of residual data from each of the multiple residual channels at the buffer.

Example 6 includes the device of Example 4 or Example 5, wherein the VPP is configured to read first residual data from a first residual channel of the multiple residual channels, second residual data from a second residual channel of the multiple residual channels, and third residual data from a third residual channel of the multiple residual channels, and wherein the first residual data, the second residual data, and the third residual data are associated with an image frame encoded in the bitstream.

Example 7 includes the device of any of Examples 3 to 6, wherein the VPP is further configured to process the header data, the first residual data, the second residual data, and the third residual data to generate a representation of the image frame.

Example 8 includes the device of any of Examples 3 to 7, wherein the VPP includes: a header processing unit configured to process the header data; and multiple pixel processing units configured to perform processing operations in parallel, wherein each pixel processing unit of the multiple pixel processing units is configured to process the residual data of a respective residual channel to generate respective pixel data, and wherein the representation of the image frame is based on the processed header data and the pixel data that is output by the multiple pixel processing units.

Example 9 includes the device of any of Examples 1 to 8, and further including a system-on-chip that includes the VSP, the VPP, and the buffer.

Example 10 includes the device of any of Examples 1 to 9, wherein the residual information is formatted according to a 4:4:4 color format or a 4:2:2 color format.

Example 11 includes the device of any of Examples 1 to 10, wherein: the one or more processors are further configured to generate a representation of an image frame encoded in the bitstream based on the residual data; and the device further comprises a display device configured to output the representation of the image frame.

Example 12 includes the device of any of Examples 1 to 11, further including a modem coupled to the one or more processors and configured to receive the bitstream from a second device.

Example 13 includes the device of any of Examples 1 to 12, wherein the one or more processors are integrated in a headset device.

Example 14 includes the device of any of Examples 1 to 12, wherein the one or more processors are integrated in at least one of a mobile phone, a tablet computer device, a wearable electronic device, or a camera device.

Example 15 includes the device of any of Examples 1 to 12, wherein the one or more processors are integrated in a vehicle.

According to Example 16, a method includes: obtaining, by one or more processors, residual information from a bitstream that corresponds to video data; and distributing, by the one or more processors, residual data based on the residual information into multiple residual channels to enable parallel decoding using the residual data from each residual channel of the multiple residual channels.

Example 17 includes the method of Example 16, and further including: parsing, by the one or more processors, the bitstream to generate the residual information, the residual information including luminance residual information, first chrominance residual information, and second chrominance residual information, wherein distributing the residual data comprises: distributing a first set of residual data that is based on the luminance residual information to a first residual channel of the multiple residual channels; distributing a second set of residual data that is based on the first chrominance residual information to a second residual channel of the multiple residual channels; and distributing a third set of residual data that is based on the second chrominance residual information to a third residual channel of the multiple residual channels.

Example 18 includes the method of Example 17, and further including: reading, by the one or more processors in parallel, first residual data from the first residual channel, second residual data from the second residual channel, and third residual data from the third residual channel; and performing, by the one or more processors in parallel, pixel processing operations on the first residual data, the second residual data, and the third residual data, to generate a representation of an image frame.

According to Example 19, a device includes: a memory configured to store video data; and one or more processors coupled to the memory, wherein the one or more processors are configured to: process an image frame of the video data to generate, in parallel, multiple sets of residual data distributed into multiple residual channels; encode the multiple sets of residual data from the multiple residual channels to generate residual information; and output a bitstream that represents the video data based on the residual information.

Example 20 includes the device of Example 19, wherein the multiple residual channels include a first channel for luminance residual information, a second channel for first chrominance residual information, and a third channel for second chrominance residual information.

Example 21 includes the device of Example 19 or Example 20, wherein the one or more processors include a video pixel processor (VPP) coupled to a buffer, and wherein the VPP is configured to process the image frame to generate, in parallel, a respective set of residual data in each of the multiple residual channels at the buffer.

Example 22 includes the device of Example 21, wherein the multiple sets of residual data include first residual data in a first residual channel of the multiple residual channels, second residual data in a second residual channel of the multiple residual channels, and third residual data in a third residual channel of the multiple residual channels, and wherein the first residual data, the second residual data, and the third residual data are based on the image frame.

Example 23 includes the device of Example 21 or Example 22, wherein the VPP is further configured to process the image frame to generate header data in a header channel at the buffer.

Example 24 includes the device of Example 23, wherein the VPP includes: a header processing unit configured to generate the header data; and multiple pixel processing units configured to generate the multiple sets of residual data in parallel with the header data, wherein each pixel processing unit of the multiple pixel processing units is configured to process the image frame to generate a respective set of residual data of a respective residual channel at the buffer.

Example 25 includes the device of Example 24, wherein the one or more processors further include a video stream processor (VSP) coupled to the buffer, and wherein the VSP is configured to read the multiple sets of residual data from the multiple residual channels in parallel and to encode the multiple sets of residual data as the residual information.

Example 26 includes the device of Example 25, wherein the VSP includes: a header encoder configured to encode the header data to generate header information; multiple residual encoders, each of the multiple residual encoders configured to encode a respective set of the residual data from a respective residual channel at the buffer to generate a portion of the residual information; and a combiner configured to combine the header information and the residual information to generate the bitstream.

Example 27 includes the device of Example 25 or Example 26, further including a system-on-chip that includes the VSP, the VPP, and the buffer.

Example 28 includes the device of any of Examples 19 to 27, wherein the residual information is formatted according to a 4:4:4 color format or a 4:2:2 color format.

Example 29 includes the device of any of Examples 19 to 28, further including a camera coupled to the one or more processors and configured to generate the video data.

Example 30 includes the device of any of Examples 19 to 29, further including a modem coupled to the one or more processors and configured to transmit the bitstream to a second device.

Example 31 includes the device of any of Examples 19 to 30, wherein the one or more processors are integrated in a headset device.

Example 32 includes the device of any of Examples 19 to 30, wherein the one or more processors are integrated in at least one of a mobile phone, a tablet computer device, a wearable electronic device, or a camera device.

Example 33 includes the device of any of Examples 19 to 30, wherein the one or more processors are integrated in a vehicle.

According to Example 34, a method includes: processing, by one or more processors, an image frame of video data to generate, in parallel, multiple sets of residual data distributed into multiple residual channels; encoding, by the one or more processors, the multiple sets of residual data from the multiple residual channels to generate residual information; and outputting, by the one or more processors, a bitstream based on the residual information, the bitstream representing the video data.

Example 35 includes the method of Example 34, wherein processing the image frame includes, in parallel: processing the image frame to generate luminance residual data in a first residual channel of the multiple residual channels; processing the image frame to generate first chrominance residual data in a second residual channel of the multiple residual channels; and processing the image frame to generate second chrominance residual data in a third residual channel of the multiple residual channels.

Example 36 includes the method of Example 34 or Example 35, wherein encoding the multiple sets of residual data includes: encoding the luminance residual data to generate luminance residual information; encoding the first chrominance residual data to generate first chrominance residual information; encoding the second chrominance residual data to generate second chrominance residual information; and combining the luminance residual information, the first chrominance residual information, and the second chrominance residual information to generate the residual information.

According to Example 37, an apparatus includes: means for obtaining residual information from a bitstream that corresponds to video data; and means for distributing residual data based on the residual information into multiple residual channels to enable parallel decoding using the residual data from each residual channel of the multiple residual channels.

Example 38 includes the apparatus of Example 37, and further including: means for parsing the bitstream to generate the residual information, the residual information including luminance residual information, first chrominance residual information, and second chrominance residual information, and wherein the multiple residual channels include a first residual channel, a second residual channel, and a third residual channel.

Example 39 includes the apparatus of Example 38, and further including: means for performing, in parallel, pixel processing operations on first residual data from the first residual channel, second residual data from the second residual channel, and third residual data from the third residual channel to generate a representation of an image frame.

According to Example 40, a non-transitory, computer-readable medium stores instructions that, when executed by one or more processors, cause the one or more processors to: obtain residual information from a bitstream that corresponds to video data; and distribute residual data based on the residual information into multiple residual channels to enable parallel decoding using the residual data from each residual channel of the multiple residual channels.

Example 41 includes the non-transitory, computer-readable medium of Example 40, wherein the instructions, when executed by the one or more processors, further cause the one or more processors to: parse the bitstream to generate the residual information, the residual information including luminance residual information, first chrominance residual information, and second chrominance residual information, wherein distributing the residual data comprises: distributing a first set of residual data that is based on the luminance residual information to a first residual channel of the multiple residual channels; distributing a second set of residual data that is based on the first chrominance residual information to a second residual channel of the multiple residual channels; and distributing a third set of residual data that is based on the second chrominance residual information to a third residual channel of the multiple residual channels.

Example 42 includes the non-transitory, computer-readable medium of Example 41, wherein the instructions, when executed by the one or more processors, further cause the one or more processors to: read, in parallel, first residual data from the first residual channel, second residual data from the second residual channel, and third residual data from the third residual channel; and perform, in parallel, pixel processing operations on the first residual data, the second residual data, and the third residual data, to generate a representation of an image frame.

According to Example 43, an apparatus includes: means for processing an image frame of video data to generate, in parallel, multiple sets of residual data distributed into multiple residual channels; means for encoding the multiple sets of residual data from the multiple residual channels to generate residual information; and means for outputting a bitstream based on the residual information, the bitstream representing the video data.

Example 44 includes the apparatus of Example 43, wherein the means for processing includes: means for processing the image frame to generate luminance residual data in a first residual channel of the multiple residual channels; means for processing the image frame to generate first chrominance residual data in a second residual channel of the multiple residual channels; and means for processing the image frame to generate second chrominance residual data in a third residual channel of the multiple residual channels.

Example 45 includes the apparatus of Example 43 or Example 44, wherein the means for encoding includes: means for encoding the luminance residual data to generate luminance residual information; means for encoding the first chrominance residual data to generate first chrominance residual information; means for encoding the second chrominance residual data to generate second chrominance residual information; and means for combining the luminance residual information, the first chrominance residual information, and the second chrominance residual information to generate the residual information.

According to Example 46, a non-transitory, computer-readable medium stores instructions that, when executed by one or more processors, cause the one or more processors to: process an image frame of video data to generate, in parallel, multiple sets of residual data distributed into multiple residual channels; encode the multiple sets of residual data from the multiple residual channels to generate residual information; and output a bitstream based on the residual information, the bitstream representing the video data.

Example 47 includes the non-transitory, computer-readable medium of Example 46, wherein processing the image frame includes, in parallel: processing the image frame to generate luminance residual data in a first residual channel of the multiple residual channels; processing the image frame to generate first chrominance residual data in a second residual channel of the multiple residual channels; and processing the image frame to generate second chrominance residual data in a third residual channel of the multiple residual channels.

Example 48 includes the non-transitory, computer-readable medium of Example 46 or Example 47, wherein encoding the multiple sets of residual data includes: encoding the luminance residual data to generate luminance residual information; encoding the first chrominance residual data to generate first chrominance residual information; encoding the second chrominance residual data to generate second chrominance residual information; and combining the luminance residual information, the first chrominance residual information, and the second chrominance residual information to generate the residual information.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A device comprising:
a memory configured to store a bitstream corresponding to video data; and
one or more processors coupled to the memory, wherein the one or more processors are configured to:
obtain header information and residual information from the bitstream;
distribute header data based on the header information into a header channel; and
distribute residual data based on the residual information into multiple residual channels to enable parallel decoding using the header data of the header channel and the residual data from each residual channel of the multiple residual channels.

2. The device of claim 1, wherein the multiple residual channels include a first residual channel for luminance residual information, a second residual channel for first chrominance residual information, and a third residual channel for second chrominance residual information.

3. The device of claim 1, wherein the one or more processors include a video stream processor (VSP) coupled to a buffer, and wherein the VSP is configured to parse the bitstream and to distribute the residual data as multiple sets of residual data into the multiple residual channels at the buffer.

4. The device of claim 3, wherein the VSP includes:
a parser configured to parse the bitstream to generate the header information and the residual information;
a header decoder configured to decode the header information to generate the header data in the header channel of the buffer; and
multiple residual decoders, each of the multiple residual decoders configured to decode a respective portion of the residual information to generate a respective set of residual data in a respective one of the multiple residual channels at the buffer.

5. The device of claim 4, wherein the one or more processors further include a video pixel processor (VPP) configured to read, in parallel, a respective set of residual data from each of the multiple residual channels at the buffer.

6. The device of claim 5, wherein the VPP is configured to read first residual data from a first residual channel of the multiple residual channels, second residual data from a second residual channel of the multiple residual channels, and third residual data from a third residual channel of the multiple residual channels, and wherein the first residual data, the second residual data, and the third residual data are associated with an image frame encoded in the bitstream.

7. The device of claim 6, wherein the VPP is further configured to process the header data, the first residual data, the second residual data, and the third residual data to generate a representation of the image frame.

8. The device of claim 7, wherein the VPP includes:
a header processing unit configured to process the header data; and
multiple pixel processing units configured to perform processing operations in parallel, wherein each pixel processing unit of the multiple pixel processing units is configured to process the residual data of a respective residual channel to generate respective pixel data, and wherein the representation of the image frame is based on the processed header data and the pixel data that is output by the multiple pixel processing units.

9. The device of claim 5, further comprising:
a system-on-chip that includes the VSP, the VPP, and the buffer.

10. The device of claim 1, wherein the residual information is formatted according to a 4:4:4 color format or a 4:2:2 color format.

11. The device of claim 1, wherein:
the one or more processors are further configured to generate a representation of an image frame encoded in the bitstream based on the residual data; and
the device further comprises a display device configured to output the representation of the image frame.

12. The device of claim 1, further comprising:
a modem coupled to the one or more processors and configured to receive the bitstream from a second device.

13. A method comprising:
obtaining, by one or more processors, header information and residual information from a bitstream that corresponds to video data;
distributing header data based on the header information into a header channel; and
distributing, by the one or more processors, residual data based on the residual information into multiple residual channels to enable parallel decoding using the header data of the header channel and the residual data from each residual channel of the multiple residual channels.

14. The method of claim 13, further comprising:
parsing, by the one or more processors, the bitstream to generate the residual information, the residual information including luminance residual information, first chrominance residual information, and second chrominance residual information,
wherein distributing the residual data comprises:
distributing a first set of residual data that is based on the luminance residual information to a first residual channel of the multiple residual channels;
distributing a second set of residual data that is based on the first chrominance residual information to a second residual channel of the multiple residual channels; and
distributing a third set of residual data that is based on the second chrominance residual information to a third residual channel of the multiple residual channels.

15. The method of claim 14, further comprising:
reading, by the one or more processors in parallel, first residual data from the first residual channel, second residual data from the second residual channel, and third residual data from the third residual channel; and
performing, by the one or more processors in parallel, pixel processing operations on the first residual data, the second residual data, and the third residual data, to generate a representation of an image frame.

16. A device comprising:
a memory configured to store video data; and
one or more processors coupled to the memory, wherein the one or more processors are configured to:
process an image frame of the video data to generate, in parallel, header data distributed into a header channel and multiple sets of residual data distributed into multiple residual channels;
encode the header data from the header channel to generate header information;
encode the multiple sets of residual data from the multiple residual channels to generate residual information; and
output a bitstream that represents the video data based on the residual information and the header information.

17. The device of claim 16, wherein the multiple residual channels include a first channel for luminance residual information, a second channel for first chrominance residual information, and a third channel for second chrominance residual information.

18. The device of claim 16, wherein the one or more processors include a video pixel processor (VPP) coupled to a buffer, and wherein the VPP is configured to process the image frame to generate, in parallel, a respective set of residual data in each of the multiple residual channels at the buffer.

19. The device of claim 18, wherein the multiple sets of residual data include first residual data in a first residual channel of the multiple residual channels, second residual data in a second residual channel of the multiple residual channels, and third residual data in a third residual channel of the multiple residual channels, and wherein the first residual data, the second residual data, and the third residual data are based on the image frame.

20. The device of claim 18, wherein the VPP is further configured to process the image frame to generate the header data in the header channel at the buffer.

21. The device of claim 20, wherein the VPP includes:
a header processing unit configured to generate the header data; and
multiple pixel processing units configured to generate the multiple sets of residual data in parallel with the header data, wherein each pixel processing unit of the multiple pixel processing units is configured to process the image frame to generate a respective set of residual data of a respective residual channel at the buffer.

22. The device of claim 21, wherein the one or more processors further include a video stream processor (VSP) coupled to the buffer, and wherein the VSP is configured to read the multiple sets of residual data from the multiple residual channels in parallel and to encode the multiple sets of residual data as the residual information.

23. The device of claim 22, wherein the VSP includes:
a header encoder configured to encode the header data to generate the header information;
multiple residual encoders, each of the multiple residual encoders configured to encode a respective set of the residual data from a respective residual channel at the buffer to generate a portion of the residual information; and
a combiner configured to combine the header information and the residual information to generate the bitstream.

24. The device of claim 22, further comprising:
a system-on-chip that includes the VSP, the VPP, and the buffer.

25. The device of claim 16, wherein the residual information is formatted according to a 4:4:4 color format or a 4:2:2 color format.

26. The device of claim 16, further comprising:
a camera coupled to the one or more processors and configured to generate the video data.

27. The device of claim 16, further comprising:
a modem coupled to the one or more processors and configured to transmit the bitstream to a second device.

28. A method comprising:
processing, by one or more processors, an image frame of video data to generate, in parallel, header data distributed into a header channel and multiple sets of residual data distributed into multiple residual channels;
encoding, by the one or more processors, the header data from the header channel to generate header information;
encoding, by the one or more processors, the multiple sets of residual data from the multiple residual channels to generate residual information; and
outputting, by the one or more processors, a bitstream based on the residual information and the header information, the bitstream representing the video data.

29. The method of claim 28, wherein processing the image frame comprises, in parallel:
processing the image frame to generate luminance residual data in a first residual channel of the multiple residual channels;
processing the image frame to generate first chrominance residual data in a second residual channel of the multiple residual channels; and
processing the image frame to generate second chrominance residual data in a third residual channel of the multiple residual channels.

30. The method of claim 29, wherein encoding the multiple sets of residual data comprises:
encoding the luminance residual data to generate luminance residual information;
encoding the first chrominance residual data to generate first chrominance residual information;
encoding the second chrominance residual data to generate second chrominance residual information; and
combining the luminance residual information, the first chrominance residual information, and the second chrominance residual information to generate the residual information.
